(19) United States
(12) Patent Application Publication
(10) Pub. No.: US 2016/0180232 A1
(43) Pub. Date: Jun. 23, 2016

(54) PREDICTION DEVICE, PREDICTION METHOD, AND NON-TRANSITORY COMPUTER READABLE STORAGE MEDIUM

(71) Applicant: YAHOO JAPAN CORPORATION, Tokyo (JP)

(72) Inventors: Kota TSUBOUCHI, Tokyo (JP); Shinnosuke WANAKA, Chiba (JP); Tomoki SAITO, Chiba (JP)

(73) Assignee: YAHOO JAPAN CORPORATION, Tokyo (JP)

(21) Appl. No.: 14/957,244

(22) Filed: Dec. 2, 2015

(30) Foreign Application Priority Data
Dec. 19, 2014 (JP) 2014-257643

(51) Int. Cl. G06N 5/04; G06N 7/00

(52) U.S. Cl. CPC G06N 5/047; G06N 7/005

(57) ABSTRACT

A prediction device according to the present application includes an acquisition unit and a prediction unit. The acquisition unit acquires sensor information related to a first user, the sensor information having been detected with a sensor. The prediction unit predicts an interest of the first user, based on an action pattern obtained from a history of the sensor information of the first user obtained by the acquisition unit, and interest information of user classification into which a second user is classified according to an action pattern obtained from a history of sensor information related to the second user.

### CROSS-REFERENCE TO RELATED APPLICATION(S)

The present application claims priority to and incorporates by reference the entire contents of Japanese Patent Application No. 2014-257643 filed in Japan on Dec. 19, 2014.

### BACKGROUND OF THE INVENTION

1. Field of the Invention

The present invention relates to a prediction device, a prediction method, and a non-transitory computer readable storage medium.

2. Description of the Related Art

In recent years, technologies for predicting information related to users have been provided. An appropriate service is provided to the users, based on such predicted information related to the users. For example, a technology for distributing content to a user according to priority of a category based on comparison between user information and a recommend rule has been provided.

However, the above-described technologies cannot necessarily predict the information related to a user in an appropriate manner. For example, if data pertaining to information related to a user to be predicted cannot be sufficiently acquired, it is difficult to appropriately predict the information related to the user.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of prediction processing according to a first embodiment;

FIG. 2 is a diagram illustrating a configuration example of a prediction system according to the first embodiment;

FIG. 3 is a diagram illustrating a configuration example of a prediction device according to the first embodiment;

FIG. 4 is a diagram illustrating an example of a user information storage unit according to the first embodiment;

FIG. 5 is a diagram illustrating an example of a user classification information storage unit according to the first embodiment;

FIG. 6 is a diagram illustrating an example of interest extraction of a user classification according to the first embodiment;

FIG. 7 is a diagram illustrating an example of extraction of an action pattern according to the first embodiment;

FIG. 8 is a flowchart illustrating an example of the prediction processing according to the first embodiment;

FIG. 9 is a diagram illustrating an example of extraction of an action pattern according to a modification;

FIG. 10 is a diagram illustrating another example of extraction of an action pattern according to a modification;

FIG. 11 is a diagram illustrating an example of prediction processing according to a second embodiment;

FIG. 12 is a diagram illustrating a configuration example of a prediction system according to the second embodiment;

FIG. 13 is a diagram illustrating a configuration example of the prediction device according to the second embodiment;

FIG. 14 is a diagram illustrating an example of a position information storage unit according to the second embodiment;

FIG. 15 is a diagram illustrating an example of a stay information storage unit according to the second embodiment;

FIG. 16 is a diagram illustrating an example of position information extraction according to the second embodiment;

FIG. 17 is a diagram illustrating an example of integration of stay points according to the second embodiment;

FIG. 18 is a diagram illustrating an example of a role of a stay point according to the second embodiment;

FIG. 19 is a flowchart illustrating an example of transition model generation processing in the prediction processing according to the second embodiment;

FIG. 20 is a diagram illustrating an example of a transition probability in a transition model according to the second embodiment;

FIG. 21 is a diagram illustrating an example of a transition time in a transition model according to the second embodiment;

FIG. 22 is a diagram illustrating an example of calculation of a transition time in a transition model according to the second embodiment;

FIG. 23 is a diagram illustrating an example of a transition time in a transition model according to the second embodiment;

FIG. 24 is a flowchart illustrating an example of the prediction processing according to the second embodiment;

FIG. 25 is a diagram illustrating combination of transition models according to the second embodiment; and

FIG. 25 is a hardware configuration diagram illustrating an example of a computer that realizes functions of a prediction device.

### DETAILED DESCRIPTION OF THE PREFERRED EMBODIMENTS

Hereinafter, embodiments for implementing a prediction device, a prediction method, and a prediction program according to the present application (hereinafter, referred to as “embodiments”) will be described in detail with reference to the drawings. Note that the prediction device, the prediction method, and the prediction program according to the present application are not limited by the embodiments. Further, the same portions in the respective embodiments are denoted with the same reference sign, and overlapping description is omitted.

### First Embodiment

1. Prediction Processing

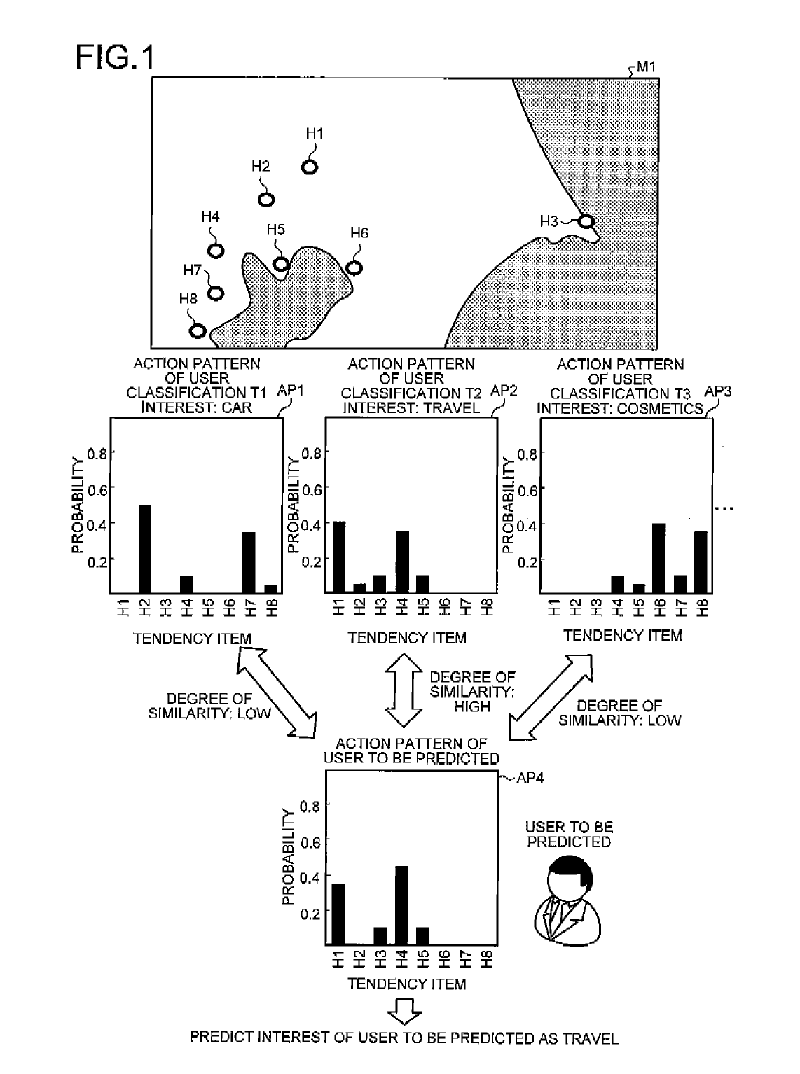

First, an example of prediction processing according to a first embodiment will be described using FIG. 1. FIG. 1 is a diagram illustrating an example of prediction processing according to the first embodiment. In the example described below, a prediction device 100 uses, as sensor information related to a first user (hereinafter, simply referred to as “user”), position information of the user. To be specific, the prediction device 100 predicts an interest of the user from which the position information has been acquired, based on the degree of similarity between an action pattern of the user from which the position information has been acquired, and an action pattern of a user classification. Hereinafter, an example in which the user from which the position information has been acquired is a user to be predicted, and the prediction device 100 predicts the interest of the user to be predicted will be described.

FIG. 1 illustrates the action patterns and the interests of user classifications T1 to T3, which are used in prediction processing by the prediction device 100 according to the first embodiment. Action patterns AP1 to AP3 that are action patterns of respective user classifications illustrated with bar graphs are configured from tendency items H1 to H8. Here, the tendency items distinguish information related to the position information of the users according to content of the information, and indicate the information as a tendency of the action, patterns of the users. Details will be described below. In the example illustrated in FIG. 1, the tendency items H1 to H8 in the action patterns AP1 to AP3 of the respective user classifications correspond to H1 to H8 indicating regions on a map Mi illustrated in FIG. 1 (hereinafter, H1 to H8 may be referred to as “region H1” and the like). Further, the heights of the bars corresponding to the tendency items H1 to H8 in the action patterns AP1 to AP3 in the respective user classifications indicate occurrence probabilities (hereinafter, simply referred to as “probabilities”) positioned in the regions H1 to H8 on the map M1. To be specific, in the example illustrated in FIG. 1, the action pattern AP1 of the user classification T1 indicates that the probability positioned in the region H2 on the map M1 is 50%, the probability positioned in the region H4 is 10%, the probability positioned in the region H7 is 35%, and the probability positioned in the region H8 is 5%. Further, the action pattern AP2 of the user classification T2 indicates that the probability positioned in the region H1 on the map M1 is 40%, the probability positioned in the region H2 is 5%, the probability positioned in the region H3 is 10%, the probability positioned in the region H4 is 35%, and the probability positioned in the region H5 is 10%. Note that the user classifications T1 to T3, and the like illustrated in FIG. 1 are generated from histories of position information of a plurality of users. Details will be described below. Further, the interests indicated above the action patterns AP1 to AP3 of the respective user classifications are associated with the respective user classifications, and indicate interests estimated to be common to the users of the user classifications. To be specific, in the example illustrated in FIG. 1, the users of the user classification T2 are estimated to have an interest in travel. Note that details of the interest of the user classification will be described below.

Here, when the prediction device 100 has acquired the history of the position information of the user to be predicted, the prediction device 100 generates the action pattern of the user to be predicted from the history of the position information of the user to be predicted. An action pattern AP4 of the user to be predicted illustrated in FIG. 1 indicates the action pattern of the user to be predicted generated by the prediction device 100. The action pattern AP4 of the user to be predicted is configured from a plurality of tendency items H1 to H8, similarly to the action patterns AP1 to AP3 of the respective user classifications. In the example illustrated in FIG. 1, the tendency items H1 to H8 in the action pattern AP4 of the user to be predicted correspond to the regions H1 to H8 on the map M1 illustrated in FIG. 1. Further, the heights of the bars corresponding to the tendency items H1 to H8 in the action pattern AP4 of the user to be predicted indicate probabilities positioned in the respective regions H1 to H8 on the map M1. To be specific, in the example illustrated in FIG. 1, the action pattern AP4 of the user to be predicted indicates that the probability positioned in the region H1 on the map M1 is 35%, the probability positioned in the region H3 is 10%, the probability positioned in the region H4 is 45%, and the probability positioned in the region H5 is 10%.

After generating the action pattern AP4 of the user to be predicted, the prediction device 100 determines a user classification into which the user to be predicted is classified, based on the action patterns AP1 to AP3 of the user classifications T1, T2, and T3, and the like, and the generated action pattern AP4 of the user to be predicted. To be specific, the prediction device 100 determines that the user classification having a highest degree of similarity to the action pattern AP4 of the user to be predicted, as the user classification into which the user to be predicted is classified, based on the degree of similarity between the action patterns of the user classifications T1, T2, and T3 and the like, and the action patterns AP4 of the user to be predicted. Note that the prediction device 100 uses various technologies related to calculation of the degree of similarity for the determination of the degree of similarity between the action patterns, such as cosine similarity.

In the example illustrated in FIG. 1, the prediction device 100 determines that the action pattern AP2 of the user classification T2, as the action pattern having the highest degree of similarity to the action pattern AP4 of the user to be predicted. Accordingly, the prediction device 100 predicts that the travel estimated to be the common interest to the users of the user classification T2, as the interest of the user to be predicted.

As described above, the prediction device 100 according to the first embodiment can estimate the interest of the user to be predicted, based on the position information of the user to be predicted. Therefore, the prediction device 100 can estimate the interest of the user to be predicted, based on the position information of the user to be predicted, even when there is no or insufficient information related to the interest of the user to be predicted.

Conventionally, technologies for providing appropriate content to the user according to the interest based on a content browsing history of the user have been provided, for example. However, when there is no or an insufficient content browsing history of the user to be predicted, it is difficult to predict the interest of the user to be predicted from the content browsing history of the user to be predicted. Therefore, when there is no or an insufficient content browsing history of the user to be predicted, there is a case where information related to another user having a similar content browsing history to the content browsing history of the user to be predicted is used. Accordingly, the insufficient content browsing history of the user to be predicted is supplemented, and the interest of the user to be predicted is estimated. However, when the degree of similarity to the another user is determined based on the insufficient content browsing history of the user to be predicted, it is difficult to appropriately determine the similar another user. Further, when there is no content browsing history of the user to be predicted, another user having a similar content browsing history cannot be determined.

The prediction device 100 according to the first embodiment predicts the interest of the user to be predicted, based on the position information of the user to be predicted. As described above, the prediction device 100 determines the user classification into which the user to be predicted is classified, using the user classifications generated based on the position information acquired from a plurality of users, and associated with the interests based on the information related to the interests acquired from the plurality of users. To be specific, the prediction device 100 determines the user classification having the highest degree of similarity to the action pattern of the user to be predicted, as the user classification into which the user to be predicted it classified, based on the degrees of similarity between the action patterns of the user classifications and the action pattern of the user to be predicted. Then, the prediction device 100 predicts the interest of the user classification into which the user to be predicted is classified, as the interest of the user to be predicted. That is, the prediction device 100 can predict the interest of the user to be predicted, based on the position information of the user to be predicted. Therefore, the prediction device 100 can appropriately predict the interest of the user to be predicted even when there is no information for predicting the interest of the user to be predicted, for example, there is no content browsing history. Therefore, appropriate content can be provided to the user to be predicted, based on the interest of the user to be predicted by the prediction device 100.

2. Configuration of Prediction System

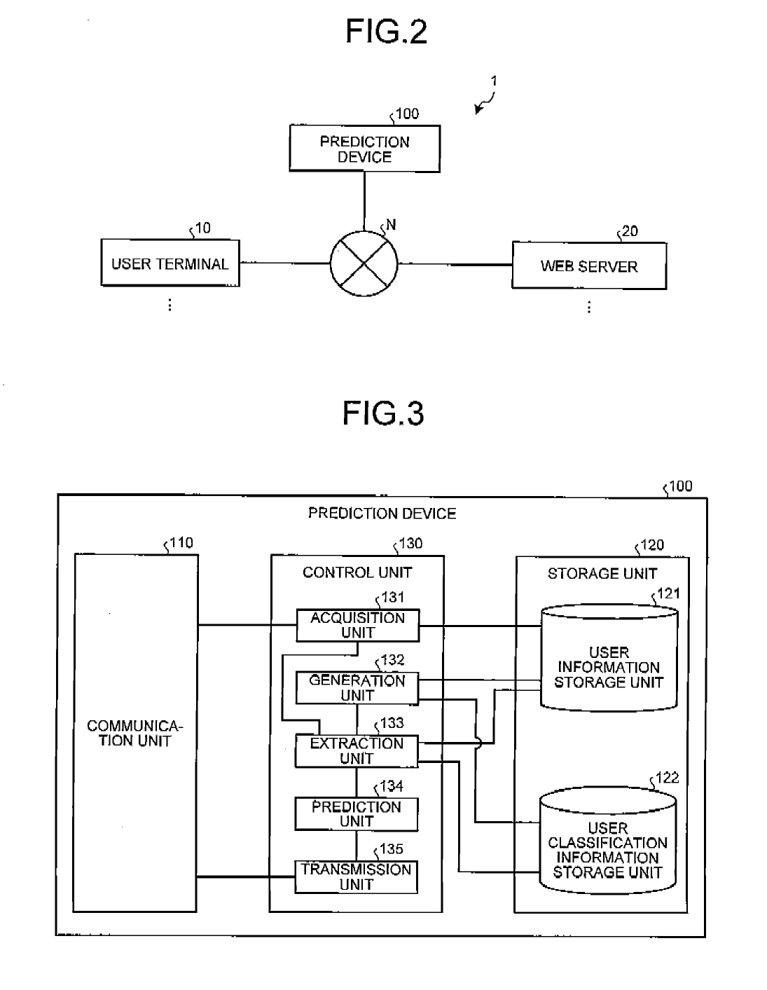

Next, a configuration of a prediction system 1 according to the first embodiment will be described using FIG. 2. FIG. 2 is a diagram illustrating a configuration example of the prediction system 1 according to the first embodiment. As illustrated in FIG. 2, the prediction system 1 includes a user terminal 10, a web server 20, and the prediction device 100. The user terminal 10, the web server 20, and the prediction device 100 are communicatively connected by wired or wireless means through a network N. Note that the prediction system 1 illustrated in FIG. 2 may include a plurality of the user terminals 10, a plurality of the web servers 20, and a plurality of the prediction devices 100.

The user terminal 10 is an information processing device used by the user. The user terminal 10 according to the first embodiment is a mobile terminal such as a smart phone, a tablet terminal, or a personal digital assistant (PDA), and detects the position information with a sensor. For example, the user terminal 10 includes a position information sensor with a GPS transmission/reception function to communicate with a global positioning system (GPS) satellite, and Acquires the position information of the user terminal 10. Note that the position information sensor of the user terminal 10 may acquire the position information of the user terminal 10, which is estimated using the position information of a base station that performs communication, or a radio wave of wireless fidelity (Wi-Fi (registered trademark)). Further, the user terminal 10 may estimate the position information of the user terminal 10 by combination of the above-describe position information. Further, the user terminal 10 transmits the acquired position information to the web server 20 and the prediction device 100.

The web server 20 is an information processing device that provides content such as a web page in response to a request from the user terminal 10. When the web server 20 acquires the position information of the user from the user terminal 10, the web server 20 transmits the history of the position information of the user of the user terminal 10 to the prediction device 100. Further, the web server 20 transmits the histories of the position information of the users of the plurality of user terminals 10, and the content browsing histories of the users of the plurality of user terminals 10 to the prediction device 100.

The prediction device 100 predicts the interest of the user to be predicted from the history of the position information of the user to be predicted. Further, the prediction device 100 generates the user classification from the histories of the position information of the users of the plurality of user terminals 10 acquired from the web server 20, for example. Further, the prediction device 100 extracts interest information of the user classification from the content browsing histories of the users of the plurality of user terminals 10 acquired from the web server 20, for example. Note that the prediction device 100 may acquire information related to the user classification, for example, information related to the action pattern and the interest information, from an information processing device outside the web server 20 and the like.

Here, an example of processing of the prediction system 1 will be given. First, the web server 20 collects the position information of the users of the plurality of user terminals 10, and information related to the content browsing of the users of the plurality of user terminals 10. The prediction device 100 acquires, from the web server 20, the histories of the position information of the users of the plurality of user terminals 10, and the content browsing histories of the users of the plurality of user terminals 10 collected by the web server 20. The prediction device 100 generates the user classification from the histories of the position information of the user of the plurality of user terminals 10 acquired from the web server 20. Further, the prediction device 100 extracts the interest information of the user classification from the content browsing histories of the users of the plurality of user terminals 10 acquired from the web server 20, and associates the interest information with the corresponding user classification. Following that, the web server 20 transmits the history of the position information of the user to be predicted whose interest is desired to be predicted, to the prediction device 100. When the prediction device 100 has acquired the history of the position information of the user to be predicted, the prediction device 100 predicts the interest of the user to be predicted, based on the history of the position information of the user to be predicted, and the generated user classification. The prediction device 100 transmits information related to the predicted interest of the user to be predicted to the web server 20. The web server 20 then provides content according to the interest of the user to be predicted, based on the information related to the interest of the user to be predicted acquired from the prediction device 100. Note that the prediction device 100 and the web server 20 may be integrated.

3. Configuration of Prediction Device

Next, a configuration of the prediction device 100 according to the first embodiment will be described using FIG. 3. FIG. 3 is a diagram illustrating a configuration example of the prediction device 100 according to the first embodiment. As illustrated in FIG. 3, the prediction device 100 includes a communication unit 110, a storage unit 120, and a control unit 130.

The communication unit 110 is realized by an NIC (Network Interface Card), or the like. The communication unit 110 is connected with the network N by wired or wireless means, and transmits/receives information to/from the user terminal 10 and the web server 20.

Storage Unit 120

The storage unit 120 is realized by a semiconductor memory device such as random access memory (RPM) or flesh memory, or a storage device such as a hard disk or an optical disk. The storage unit 120 according to the first embodiment includes, as illustrated in FIG. 3, a user information storage unit 121 and a user classification information storage unit 122.

User Information Storage Unit 121

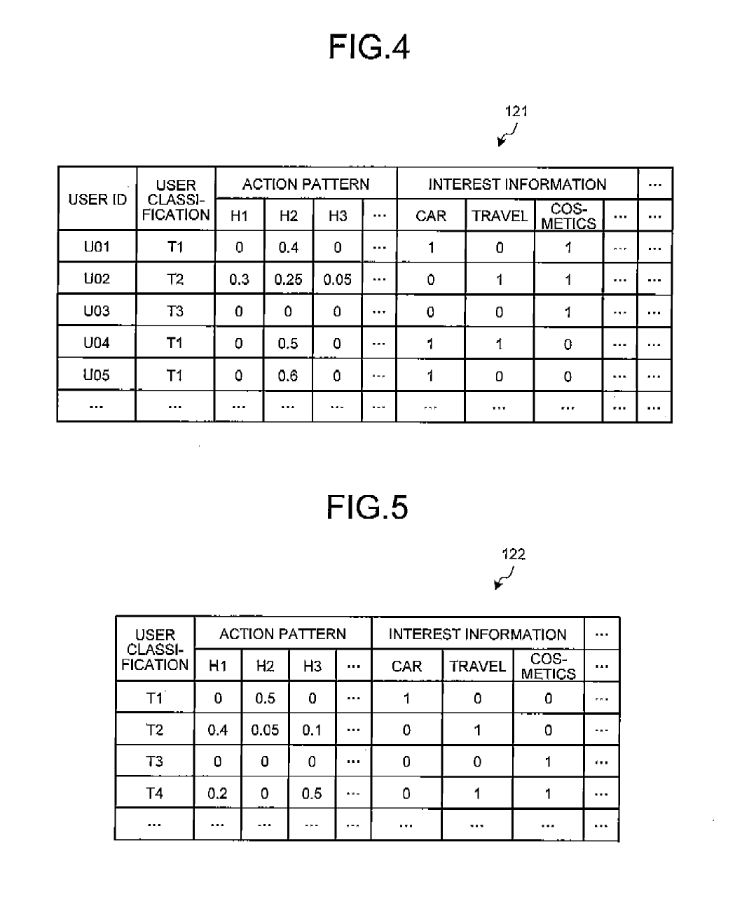

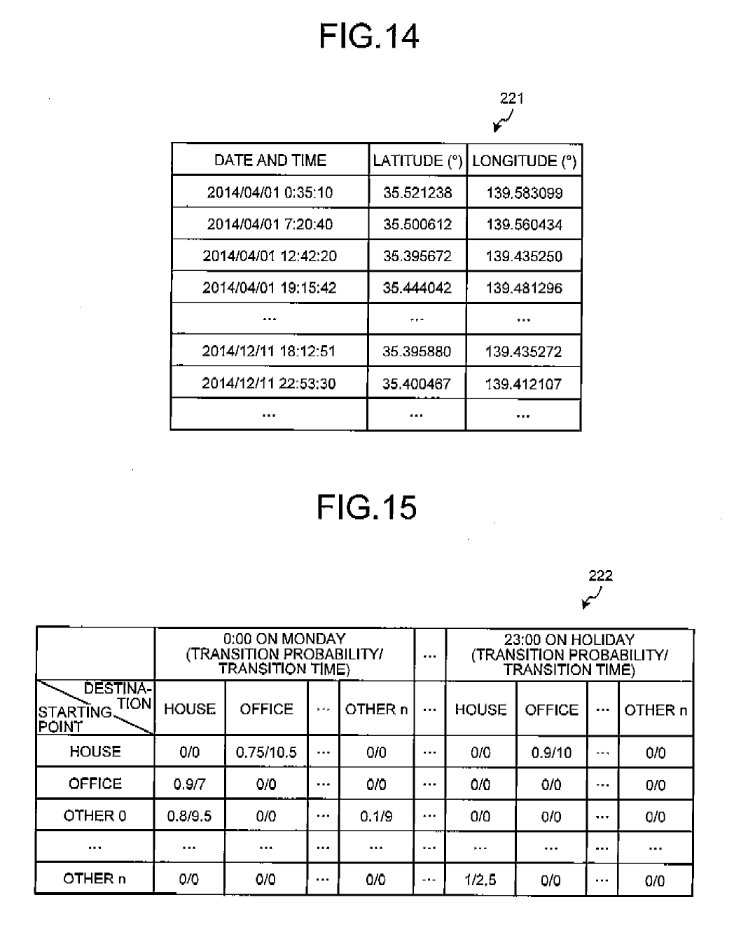

The user information storage unit 121 according to the first embodiment stores the information related to the action pattern and the interest information extracted for each user, as user information. Further, the user information storage unit 121 may store the position information of the user used for extracting the action pattern of each user (for example, longitude-latitude information illustrated in FIG. 14), the content browsing history of the user used for extracting the interest information of each user, and the like. FIG. 4 illustrates an example of the user information stored in the user information storage unit 121. As illustrated in FIG. 4, the user information storage unit 121 includes, as the user information, items such as a “user ID”, a “user classification”, an “action pattern”, “interest information”, and the like.

The “user ID” indicates identification information for identifying the user. When the same user uses a plurality of the user terminals 10, the user information storage unit 121 may store the user IDs as the same user ID as long as the user can be identified as the same user.

The “user classification” indicates the user classification into which the user is classified. For example, in the example illustrated in FIG. 4, a user identified with a user ID “U01” is classified into the user classification “T1”. Further, a user identified with a user ID “U02” is classified into the user classification “T2”.

The “action pattern” indicates an action pattern obtained from the history of the position information of the user. In the example illustrated in FIG. 4, the user information storage unit 121 stores, as the “action pattern”, stores an occurrence probability of each of a plurality of tendency items, the occurrence probability having been extracted from the history of the position information of the user. To be specific, the user information storage unit 121 stores, as the “action pattern”, the respective occurrence probabilities of “H1”, “H2”, “H3”, and the like that are the plurality of tendency items. Note that the plurality of tendency items “H1”, “H2”, “H3”, and the like illustrated in FIG. 4 is similar to those illustrated in FIG. 1. For example, the user information storage unit 121 stores that, in the action pattern of the user identified with the user ID “U01”, the occurrence probability of the tendency item “H1” is “0%”, the occurrence probability of the tendency item “H2” is “40%”, the occurrence probability of the tendency item “H3” is “0%”, and the like. Here, it is indicated that a possibility that the user performs the action corresponding to the tendency item is higher, that is, the user has a custom or a habit (that may be collectively referred to as “tendency”) to perform the action corresponding to the tendency item, as the occurrence probability of the tendency item is larger. That is, the user identified with the user ID “U01” has a tendency to perform the action corresponding to the tendency item “H2”, and has no tendency to perform the actions corresponding to the tendency items “H1” and “H3”.

The “interest information” indicates existence/non-existence of the interest of the user for a predetermined object. In the example illustrated in FIG. 4, the user information storage unit 121 stores, as the “interest information”, the predetermined objects of “car”, “travel”, “cosmetics”, and the like, and stores whether the user has an interest in the “car”, the “travel”, the “cosmetics”, and the like. To be specific, the user information storage unit 121 stores “1” for the object estimated that the user has an interest, and “0” for the object estimated that the user has no interest. For example, the user information storage unit 121 stores that the user identified with the user ID “U01” has an interest in the “car” and the “cosmetics”, and has no interest in the “travel”.

User Classification Information Storage Unit 122

The user classification information storage unit 122 according to the first embodiment stores, as user classification information, the information related to the action pattern of each user classification, and the interest information. FIG. 5 illustrates an example of the user classification information stored in the user classification information storage unit 122. As illustrated in FIG. 5, the user classification information storage unit 122 includes, as the user classification information, items such as a “user classification”, an “action pattern”, “interest information”, and the like.

The “user classification” indicates the user classification. The “action pattern” indicates the action pattern of the user classified into the user classification. The “interest information” indicates existence/non-existence of the interest of the user classified into the user classification, for the predetermined object.

In the example illustrated in FIG. 5, the user classification information storage unit 122 stores, as the “action pattern”, an occurrence probability of each of the plurality of tendency items associated with the user classification. To be specific, the user classification information storage unit 122 stores, as the “action pattern”, the respective occurrence probabilities of “H1”, “H2”, and “H3” that are the plurality of tendency items. Note that the plurality of tendency items “H1”, “H2”, “H3”, and the like illustrated in FIG. 5 is similar to those illustrated in FIG. 1. For example, the user classification information storage unit 122 stores that, in the action patterns associated with the user classification “T2”, the occurrence probability of the tendency item “H1” is “40%”, the occurrence probability of the tendency item “H2” is “5%”, and the occurrence probability of the tendency item “H3” is “10%”. Here, it is found that a possibility that the user classified into the user classification performs the action corresponding to the tendency item is higher, that is, the user has a tendency to perform the action corresponding to the tendency item, as the occurrence probability of the tendency item is larger. That is, it is found that the user classified into the user classification “T2” has a tendency to perform the action corresponding to the tendency item “H1”, and has no tendency to perform the action corresponding to the tendency item “H2”.

In the example illustrated in FIG. 5, the user classification information storage unit 122 stores, as the “interest information”, predetermined objects of “car”, “travel”, “cosmetics”, and the like, and stores whether the user classified into the user classification has an interest in the “car”, the “travel”, the “cosmetics”, and the like. To be specific, the user classification information storage unit 122 stores “1” for the object estimated that the user classified into the user classification has an interest, and “0” for the object estimated that the user classified into the user classification has no interest. For example, the user classification information storage unit 122 stores that the user classified into the user classification “T3” has an interest in the “cosmetics”, and has no interest in the “car” and the “travel”.

Control Unit 130

Referring back to the description of FIG. 3, the control unit 130 is realized by execution of various programs (corresponding to examples of the prediction program) stored in a storage device inside the prediction device 100, by a CPU (Central Processing Unit), an MPU (Micro Processing Unit), or the like, using RAM as a work area. Further, the control unit 130 is realized by an integrated circuit such as an ASIC (Application specific Integrated Circuit) or an FPGA (Field Programmable Gate Array).

As illustrated in FIG. 3, the control unit 130 includes an acquisition unit 131, a generation unit 132, an extraction unit 133, a prediction unit 134, and a transmission unit 135, and realizes or executes functions and actions of information processing described below. Note that the internal configuration of the control unit 130 is not limited to the configuration illustrated in FIG. 3, and may be another configuration as long as the configuration performs the information processing described below. Further, connection relationship of the processing units included in the control unit 130 is not limited to the connection relationship illustrated in FIG. 3, and may be another connection relationship.

Acquisition Unit 131

The acquisition unit 131 acquires sensor information related to the user detected with the sensor. In the first embodiment, the acquisition unit 131 acquires, as the sensor information related to the user, the position information of the user. For example, the acquisition unit 131 acquires the history of the position information of the user to be predicted. When the acquisition unit 131 has acquired the history of the position information of the user to be predicted, the acquisition unit 131 may transmit the acquired history of the position information of the user to be predicted to the extraction unit 133, or may store the acquired history in the user information storage unit 121. Further, when the acquisition unit 131 has acquired the position information of the user to be predicted, the acquisition unit 131 transmits the acquired position information to the extraction unit 133. Note that the acquisition unit 131 may acquire the histories of the position information of a plurality of users. Further, the acquisition unit 131 may acquire the content browsing histories of a plurality of users. Further, the acquisition unit 131 may acquire the information related to the user classification, the information related to the action pattern pertaining to the user classification, and the interest information.

Generation Unit 132

The generation unit 132 generates the user classifications, based on the sensor information corresponding to each of a plurality of tendency items for each of the plurality of users, the tendency items having been extracted by the extraction unit 133 described below, when the histories of the position information of the plurality of users have been acquired by the acquisition unit 131. To be specific, the generation unit 132 generates the user classifications, based on the degrees of similarity of distribution of the sensor information corresponding to each of the plurality of tendency items. For example, the generation unit 132 generates a plurality of the user classifications such as the user classifications T1 to T4 illustrated in FIG. 5, from the information related to the action patterns of the plurality of users of the user IDs “U01” to “U05” illustrated in FIG. 4 (hereinafter, may be referred to as “user of U01” and the like). For example, the generation unit 132 may appropriately use various clustering techniques such as a K average method or cosine similarity, in the generation of the user classifications. Further, the generation unit 132 may repeatedly generate the user classification until the user classification satisfies a predetermined condition. Note that the prediction device 100 may not include the generation unit 132 when the acquisition unit 131 acquires the information related to the user classification.

Extraction Unit 133

The extraction unit 133 extracts, based on histories of sensor information of a second user group, tendency items into which each sensor information included in the histories is classified according to content, and which indicate a tendency of an action of the second user group, and extracts the sensor information corresponding to each of a plurality of tendency items from the history of the sensor information of each second user (hereinafter, referred to as “another user”). Note that the first user and the second user may be the same person. In the first embodiment, the extraction unit 133 extracts the plurality of tendency items that classifies each position information included in the history according to content, and that indicates the tendency of the action of the another user, based on the history of the position information of the another user, and extracts the sensor information corresponding to each of the plurality of tendency items from the history of the sensor information of each another user. For example, the extraction unit 133 extracts an occurrence probability of each of the plurality of tendency items, as distribution of the sensor information corresponding to each of the plurality of tendency items, from the history of the sensor information of each another user. Further, the extraction unit 133 may repeatedly perform extraction until a predetermined condition is satisfied. In such extraction by the extraction unit 133, a technology of mechanical learning such as a habit model described in McInerney, James, Zheng, Jiangchuan, Rogers, Alex and Jennings, Nicholas R., “Modelling Heterogeneous Location Habits in Human Populations for Location Prediction Under Data Sparsity”, International Joint Conference on Pervasive and Ubiquitous Computing (UbiComp 2013), Zurich, CH, 08-12 Sep. 2013. 10 pp, 469-478 may be used. For example, the extraction unit 133 may extract, as the tendency item, an item related to information common to the sensor information of each another user. For example, the extraction unit 133 may extract, as the tendency item, an item related to information common among the sensor information of other users belonging to the same user classification, and different among the sensor information of other users belonging to different user classifications. Further, the extraction unit 133 stores, in the user information storage unit 121, the occurrence probability of each of the plurality of tendency items, as the distribution of the position information corresponding to each of the plurality of tendency items, for each user. Note that the extraction unit 133 may repeatedly perform the extraction until the user classification generated by the generation unit 132 satisfies a predetermined condition. Further, the extraction unit 133 may not perform the extraction when the acquisition unit 131 acquires the information related to the user classification. The extraction unit 133 may use a detection time of the sensor information corresponding to each of the plurality of tendency items or the number of times of detection, as the distribution of the sensor information corresponding to each of the plurality of tendency items.

The extraction unit 133 may extract the interest information of each user from the content browsing histories of the plurality of users, when the content browsing histories of the plurality of users have been acquired by the acquisition unit 131. Further, the extraction unit 133 extracts the interest information of the user classification, from the interest information of another user classified into the user classification. In the first embodiment, the extraction unit 133 extracts the interest information of the user classification, from the interest information of the plurality of users classified into the user classification. The extraction unit 133 stores the extracted interest information of the user classification in the user classification information storage unit 122 in association with the user classification.

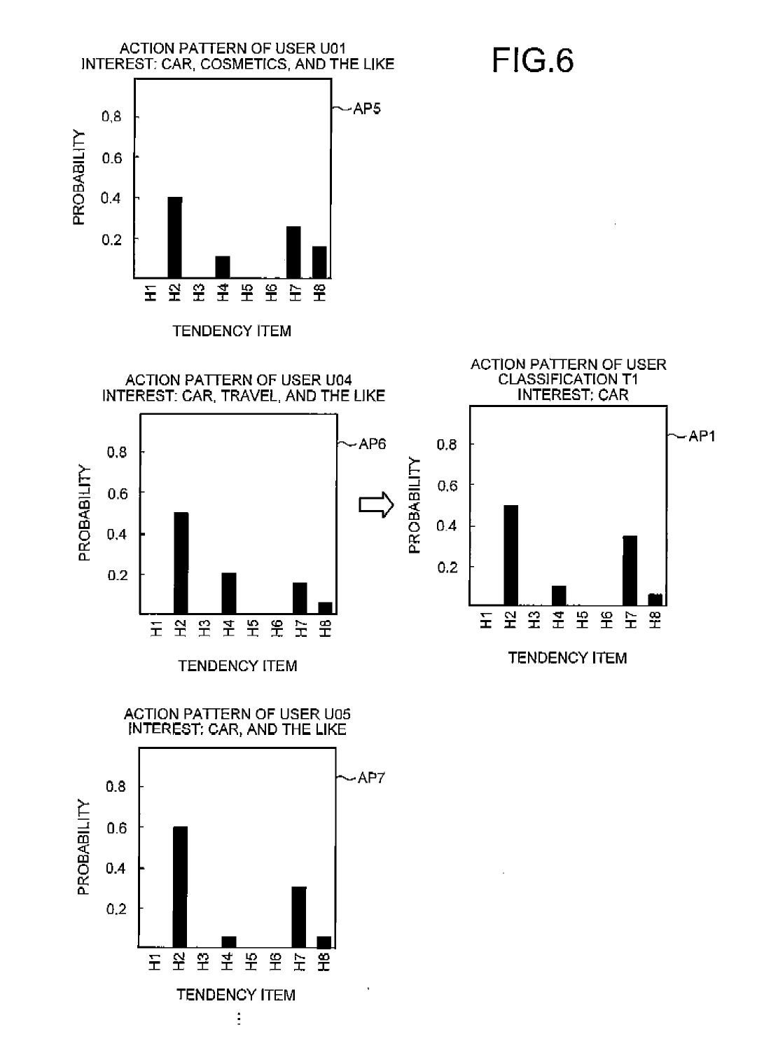

Here, a case in which the extraction unit 133 extracts the interest information of the user classification, from the interest information of other users classified into the user classification will be described using FIG. 6. FIG. 6 is a diagram illustrating an example of interest extraction of the user classification. The users such as U01, U04, and U05 with the action patterns and interests illustrated in FIG. 6 are users classified into the same user classification T1, as illustrated in FIG. 4. Here, the user of U01 has the “car”, the “cosmetics”, and the like, and does not have the “travel”, as the interests. Further, the user of U04 has the “car”, the “travel”, and the like, and does not have the “cosmetics”, as the interests. Further, the user of U05 has the “car”, and the like, and does not have the “travel”, and the “cosmetics”, and the like, as the interests. In the example illustrated in FIG. 6, the extraction unit 133 associates the “car”, which is the object that all of the users U01, U04, and U05 classified into the user classification T1 commonly have an interest, as the interest information of the user classification T1.

Note that the extraction unit 133 may use the interest information of the user who is classified into the user classification T1 and has the largest browsing history of content, as the interest information of the user classification T1. Further, the extraction unit 133 may use the interest information common to the users who are classified into the user classification T1, and the users of a predetermined number (for example, five) counted in order from the user having the largest browsing history of content, as the action pattern of the user classification T1. Further, the extraction unit 133 may use the interest information common to the users of a predetermined number (for example, five), of all of the users classified into the user classification T1, as the interest information of the user classification T1.

Further, in the example illustrated in FIG. 6, the extraction unit 133 uses an average of the action patterns of the users who are classified into the user classification T1, as the action pattern AP1 of the user classification T1. For example, the extraction unit 133 uses an average of the action pattern AP5 of the user of U01, the action pattern AP6 of the user of U04, the action pattern AP7 of the user of U05, and the like, as the action pattern AP1 of the user classification T1. Note that the extraction unit 133 may use the action pattern of the user who is classified into the user classification T1, and has the largest number of browsing of the position information, as the action pattern of the user classification T1. Further, the extraction unit 133 may use the action pattern of the users who are classified into the user classification T1, and the users of a predetermined number (for example, five) counted in order from the user having the largest number of browsing of the position information, as the action pattern of the user classification T1. Further, the extraction unit 133 may use an average of the action patterns weighted based on larger or smaller number of browsing of the position information of the users classified into the user classification T1, a so-called weighted average, as the action pattern of the user classification T1.

Further, the extraction unit 133 extracts the sensor information corresponding to each of the plurality of tendency items, from the history of the sensor information of the user. In the first embodiment, the extraction unit 133 extracts the sensor information corresponding to the plurality of tendency items, from the history of the position information of the user to be predicted. Further, the extraction unit 133 may not perform the extraction, from the history of the position information of another user, when the acquisition unit 131 acquires the information related to the user classification.

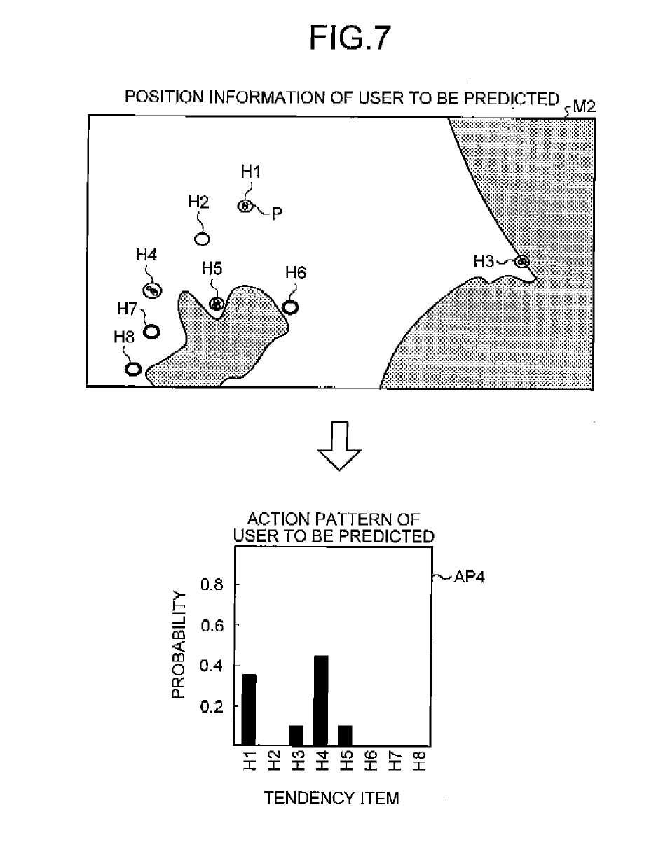

A case in which the extraction unit 133 extracts the distribution of the position information corresponding to each of the plurality of tendency items, that is, the action pattern, from the history of the position information of the user to be predicted, will be described using FIG. 7. FIG. 7 is a diagram illustrating an example of extraction of the action pattern. Note that a map M2 of the position information of the user to be predicted, which is illustrated in FIG. 7, illustrates a similar range to the map M1 illustrated in FIG. 1. A plurality of points P from which the position information has been acquired are illustrated on the map M2 of FIG. 7. Note that P is attached to only one point in FIG. 7, and P is omitted in other points. The extraction unit 133 extracts the sensor information corresponding to each of the plurality of tendency items, from the history of the position information of the user to be predicted, based on the point P included in the plurality of tendency items H1 to He on the map M2 illustrated in FIG. 7, and extracts the occurrence probability of each of the plurality of tendency items. On the map M2 illustrated in FIG. 7, the point P is included in the tendency items H1, H3, H4, and H5, and the point P is not included in the tendency items H2, H6, H7, and H8. In the example illustrated in FIG. 7, the extraction unit 133 extracts an action pattern AP4 of the user to be predicted, from the position information of the user to be predicted illustrated on the map M2. Here, the action pattern AP4 of the user to be predicted illustrated in FIG. 7 is similar to the action pattern AP4 illustrated in FIG. 1, and indicates that the probability positioned in the region H1 on the map M2 is 35%, the probability positioned in the region H3 is 10%, the probability positioned in the region H4 is 45%, and the probability positioned in the region H5 is 10%.

Prediction Unit 134

The prediction unit 134 predicts the interest of the user, based on the action pattern obtained from the history of the sensor information of the user acquired by the acquisition unit 131, and the interest information of the user classification into which another user is classified according to the action pattern obtained from the history of the sensor information related to the another user. In the first embodiment, the prediction unit 134 predicts the interest of the user to be predicted, from the interest information of the user classification into which the user to be predicted is classified, based on the degree of similarity between the distribution of the sensor information corresponding to each of the plurality of tendency items in the user to be predicted, the distribution having been extracted by the extraction unit 133, and the distribution of the sensor information corresponding to each of the plurality of tendency items associated with each user classification. To be specific, the prediction unit 134 predicts the interest of the user to be predicted, from the interest information of the user classification into which the user to be predicted is classified, based on the degree of similarity between the occurrence probability of each of the plurality of tendency items in the user to be predicted, the occurrence probability having been extracted from the extraction unit 133, and the occurrence probability of each of the plurality of tendency items associated with each user classification.

For example, in the example illustrated in FIG. 1, the prediction unit 134 uses the user classification having the highest degree of similarity to the action pattern of the user to be predicted, as the user classification into which the user to be predicted is classified, based on the degrees of similarity between the action patterns of the user classifications T1, T2, T3, and the like, and the action pattern of the user to be predicted. Note that the prediction unit 134 may use various technologies related to calculation of the degree of similarity, such as cosine similarity, for the determination of the degree of similarity between the action patterns. In the example illustrated in FIG. 1, the prediction unit 134 determines the action pattern of the user classification T2, as the action pattern having the highest degree of similarity to the action pattern of the user to be predicted. The prediction unit 134 then predicts the travel estimated to be the common interest to the users of the user classification T2, as the interest of the user to be predicted.

Transmission Unit 135

The transmission unit 135 transmits the prediction information generated by the prediction unit 134 to the web server 20. To be specific, the transmission unit 135 transmits, to the web server 20, information indicating that the interest of the user to be predicted by the prediction unit 134 is the travel.

4. Flow of Prediction Processing

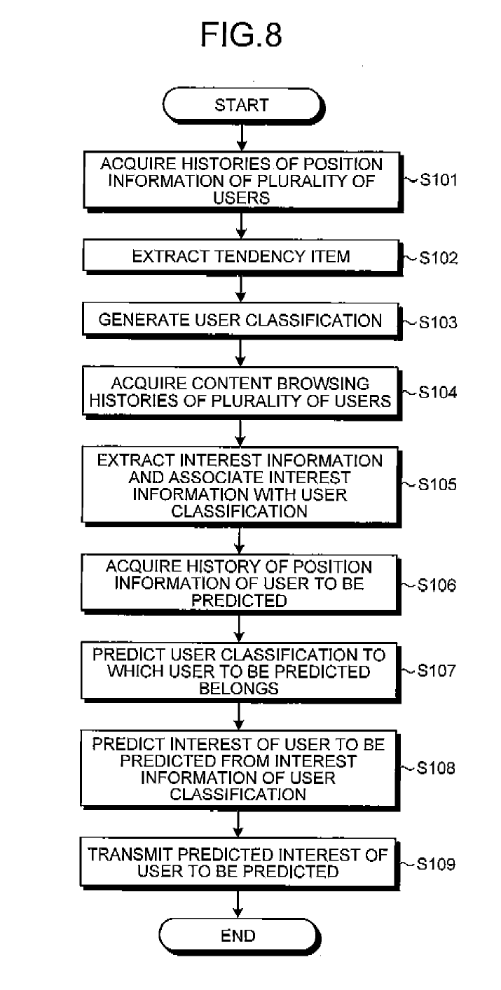

Next, a process of the prediction processing by the prediction system 1 according to the first embodiment will be described using FIG. 8. FIG. 8 is a flowchart illustrating a process of prediction processing by the prediction system 1 according to the first embodiment.

As illustrated in FIG. 8, the prediction device 100 acquires the histories of the position information of the plurality of users (step S101). The prediction device 100 then extracts the plurality of tendency items from the acquired histories of the position information of the plurality of users (step S102). The prediction device 100 then generates the user classification, based on the action pattern of each user indicated by the plurality of extracted tendency items (step S103).

Further, the prediction device 100 acquires the content browsing histories of the plurality of users (step S104). The prediction device 100 then extracts the interest information from the acquired content browsing histories of the plurality of users, and associates the interest information with the user classification (step S105). Note that the acquisition of the histories of the position information of the plurality of users in step S101, and the acquisition of the content browsing histories of the plurality of users in step S104 may be performed at the same time, or step S104 may be performed in advance of step S101. Further, when acquiring the information related to the user classification, the prediction device 100 may not perform the processing from steps S101 to S105.

When the prediction device 100 has acquired the history of the position information of the user to be predicted (step S106), the prediction device 100 then predicts the user classification to which the user to be predicted belongs (step S107). The prediction device 100 then predicts the interest of the user to be predicted from the interest information of the user classification (step S108). Following that, the prediction device 100 transmits the predicted interest of the user to be predicted to the web server 20 as the prediction information (step S109).

5. Modifications

The prediction system 1 according to the first embodiment may be implemented in various different forms, in addition to the first embodiment. Therefore, hereinafter, other embodiments of the prediction system 1 will be described.

5-1. Tendency Item including Time

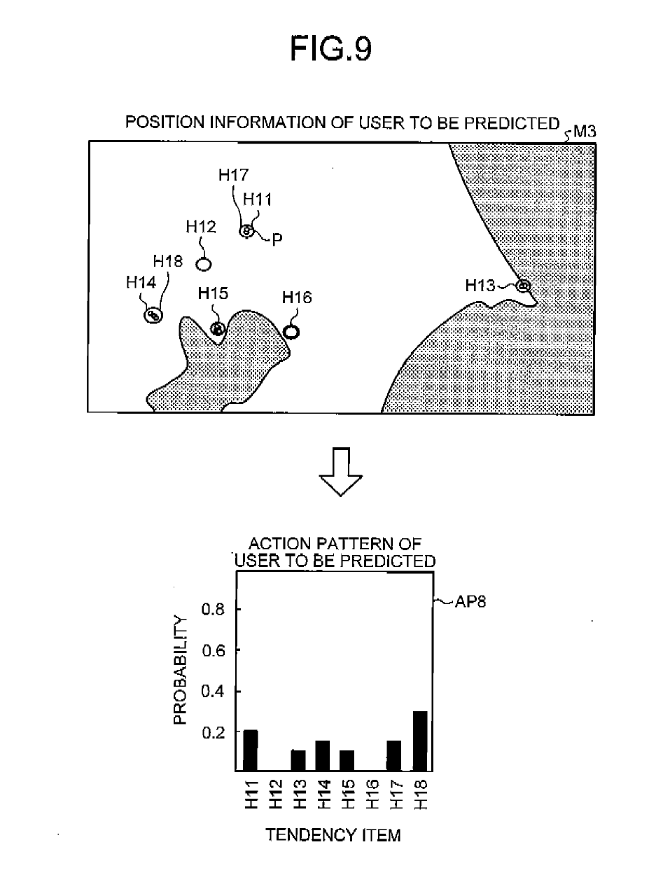

In the first embodiment, the prediction device 100 predicts the interest of the user, based on the degree of similarity of the action patterns indicated by the tendency items based only on the position information of the users. However, the prediction device 100 may predict the interest of the user, based on the degree of similarity of the action patterns indicated by the tendency items in which other information is added to the position information of the users. This point will be described using FIG. 9. FIG. 9 is a diagram illustrating an example of extraction of an action pattern according to a modification. Note that the example illustrated in FIG. 9 describes a case in which information related to a time when position information has been acquired is added to the position information of the user. Position information of a user to be predicted illustrated in FIG. 9 is similar to the position information of the user to be predicted illustrated in FIG. 1.

A map M3 illustrated in FIG. 9 includes regions H11 to H18 corresponding to tendency items H11 to H18 extracted based on position information of a plurality of users and times when the position information has been acquired. Here, the region H11 and the region H17 indicate geographically the same region on the map M3 of FIG. 9. In the example illustrated in FIG. 9, the tendency item H11 is a tendency item indicating “being positioned in the region H11 in the morning”, and the tendency item H17 is a tendency item indicating “being positioned in the region H17 in the afternoon”. As described above, the tendency items H11 and H17 indicate geographically the same position, but indicate temporally different points of time. Further, the region H14 and the region H18 indicate geographically the same region, but the tendency item H14 is a tendency item indicating “being positioned in the region H14 in the morning”, and the tendency item H18 is a tendency item indicating “being positioned in the region H18 in the afternoon” on the map M3 of FIG. 9. As described above, the tendency items H14 and H18 indicate geographically the same position, but indicate temporally different points of time.

The prediction device 100 extracts distribution of the sensor information corresponding to each of the tendency items H11 to H18, from the history of the sensor information of the user to be predicted, using the tendency items H11 to H18 extracted based on the position information and the time when the position information has been acquired, and extracts the occurrence probability of each of the tendency items H11 to H18. An action pattern AP8 of the user to be predicted illustrated in FIG. 9 indicates the occurrence probability of each of the tendency items H11 to H18. Here, the action pattern AP8 of the user to be predicted illustrated in FIG. 9 indicates that the probability of being positioned in the region H11 on the map M3 in the morning is 20%, the probability of being positioned in the region H13 is 10%, the probability of being positioned in the region H14 in the morning is 15%, the probability of being positioned in the region H15 is 10%, the probability of being positioned in the region H17 in the afternoon is 15%, and the probability of being positioned in the region H18 is 30%. Meanwhile, the action pattern AP4 of the user to be predicted illustrated in FIG. 1 indicates that the probability of being positioned in the region H1 of the map M1 is 35%, the probability of being positioned in the region H3 is 10%, and the probability of being positioned in the region H4 is 45%, and the probability of being positioned in the region H5 is 10%. In this way, when the tendency item is extracted based on the position information and the time when the position information has been acquired, the action pattern of the user can be more precisely classified. Accordingly, the prediction device 100 can more appropriately determine the user classification into which the user to be predicted is classified. Therefore, the prediction device 100 can more appropriately predict the interest of the user to be predicted.

5-2. Tendency Item of Conceptualized Position Information

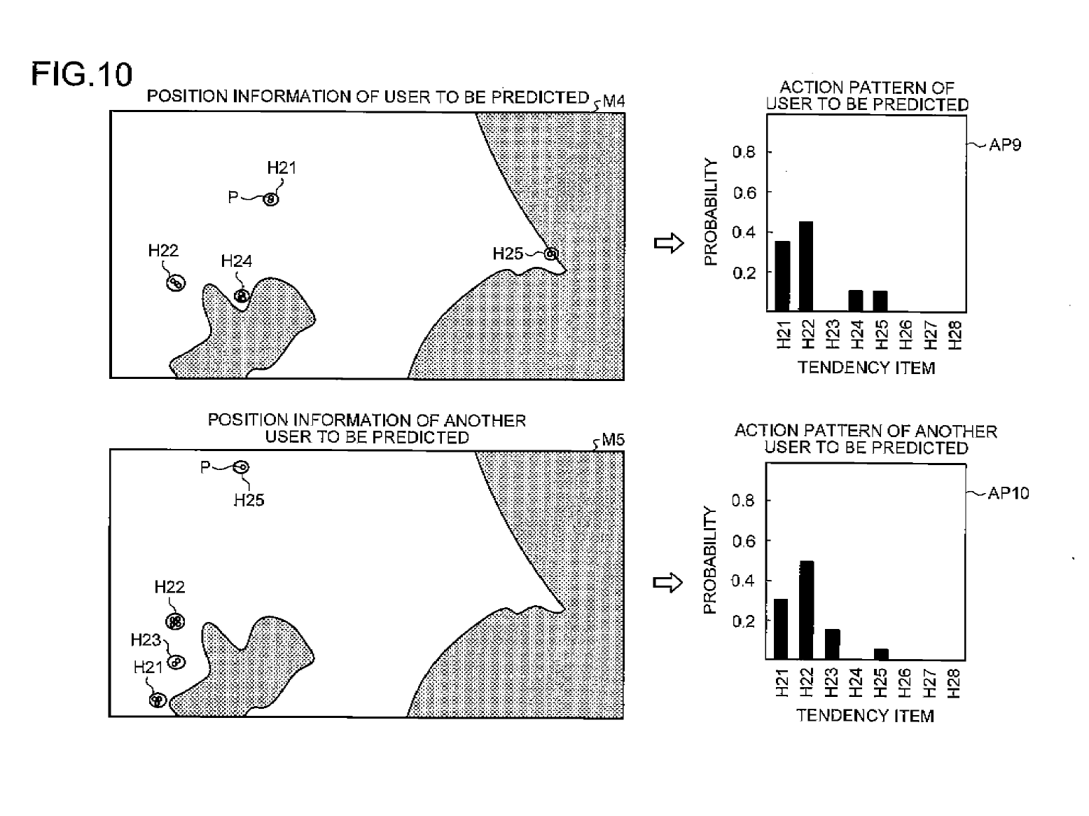

In the first embodiment, the prediction device 100 predicts the interest of the user, based on the degree of similarity of the action patterns indicated by the tendency items based on the absolute position information of the user such as longitude, latitude, and the like. In other word, in the first embodiment, the prediction device 100 predicts the interest of the user, based on the degree of similarity of the action patterns indicated by the tendency items based on where on the earth indicated in longitude and latitude the user is positioned. However, the prediction device 100 may predict the interest of the user, based on the degree of similarity of the action patterns indicated by the tendency items based on information that is conceptualized position information of the user depending on the intended use. This point will be described using FIG. 10. FIG. 10 is a diagram illustrating another example of extraction of an action pattern according to a modification. Note that position information of a user to be predicted illustrated in FIG. 10 is similar to the position information of the user to be predicted illustrated in FIG. 1.

In the example illustrated in FIG. 10, a case will be described, in which an interest of a user is predicted based on the degree of similarity of action patterns indicated by tendency items based on a role provided to position information of the user. The role provided to the position information means a function unique to each user and provided to each position in life of the user, such as “house”, “office”, “commuting route”, “leisure spot”, or “travel destination”. That is, a function provided to each position for each user may differ. For example, a position indicates the “house” for a certain user while the position indicates the “office” or the “travel destination” for another user. In other words, the position information is conceptualized to a role such as the “house” or the “office” provided to each position. Accordingly, the prediction device 100 can classify users having similar life style into the same user classification, even if the users live in different regions.

In the example illustrated in FIG. 10, a tendency item H21 is a tendency item indicating “being positioned in a region H21 that indicates a house”, and a tendency item H22 is a tendency item indicating “being positioned in a region H22 that indicates an office”. Further, a tendency item H23 is a tendency item indicating “being positioned in a region H23 that indicates a commuting route”, and a tendency item H24 is a tendency item indicating “being positioned in a region H24 that indicates a leisure spot”. Further, a tendency item H25 is a tendency item indicating “being positioned in a region H25 that indicates a travel destination”, and tendency items H26 to H28 are tendency items indicating “being positioned in regions H26 to H28 that indicate other roles 1 to 3”.

The prediction device 100 extracts the sensor information corresponding to each of the tendency items H21 to H22, from a history of position information of the user to be predicted, and a history of position information of another user to be predicted, using the tendency items H21 to H28 extracted based on the roles provided to the position information of a plurality of users, and extracts an occurrence probability of each of the tendency items H21 to H28. Here, the regions H21 to H28 corresponding to the tendency items H21 to H28 are included on a map M4 that illustrates the position information of the user to be predicted and on a map M5 that illustrates the position information of the another user to be predicted, illustrated in FIG. 10.

The regions H23, and H26 to H28 are not included on the map M4 of FIG. 10. This means that the position information having the roles corresponding to the tendency items H23, and H26 to H28 are not included in the history of the position information of the user to be predicted. For example, the position information corresponding to the tendency item H23 is not included in the history of the position information of the user to be predicted. Further, the regions H24, and H26 to H28 are not included on the map M5 of FIG. 10. This means that the position information having the roles corresponding to the tendency items H24, and H26 to H28 is not included in the history of the position information of another user to be predicted. For example, the position information corresponding to the tendency item H24 is not included in the history of the position information of the another user to be predicted. Like the example illustrated on the map M4 and M5 of FIG. 10, there is a case where the region corresponding to the same tendency item is in the different positions according to the life styles of respective users, by use of the tendency item extracted based on the role provided to the position information. For example, while the region H21 that indicates the house of the user to be predicted on the map M4 in FIG. 10 is positioned, in an approximately central portion on the map, the region H21 that indicates the house of the another user to be predicted on the map M5 in FIG. 10 is positioned in a lower left portion on the map M5.

An action pattern AP9 of the user to be predicted illustrated in FIG. 10 indicates the occurrence probability of each of the tendency items H21 to H28. Here, the action pattern AP9 of the user to be predicted illustrated in FIG. 10 indicates that the probability positioned in the region H21 that indicates the house on the map M4 is 35%, the probability positioned in the region H22 that indicates the office is 45%, the probability positioned in the region H24 that indicates the leisure spot is 10%, and the probability positioned in the region H25 that indicates the travel destination is 10%. Meanwhile, an action pattern AP10 of the another user to be predicted illustrated in FIG. 10 indicates that the probability positioned in the region H21 that indicates the house on the map M5 is 30%, the probability positioned in the region H22 that indicates the office is 50%, the probability positioned in the region H23 that indicates the commuting route is 15%, and the probability positioned in the region H25 that indicates the travel destination is 5%.

The users having the substantially different position information like the user to be predicted and the another user to be predicted having the position information illustrated on the maps M4 and M5 of FIG. 10 may have a high degree of similarity between the action patterns based on the tendency items according to the roles of the position information. In this way, when the degree of similarity between the action patterns based on the tendency items according to the roles of the position information is high, the users can be classified into the same user classification even if the users have different position information. That is, the prediction device 100 can determine the user classification into which the user to be predicted is classified according to the life style. Therefore, the prediction device 100 can more appropriately predict the interest of the user to be predicted. Note that various conventional technologies may be appropriately used to estimate what kind of region indicates which role. For example, the region where approximate position information is acquired from the night to the morning may be estimated as the house. Further, for example, the region where approximate position information is acquired in the daytime on a weekday may be estimated as the office.

5-3. Interest Information

In the first embodiment, the prediction device 100 predicts the interest of the user to be predicted, using the interest information of the car, the travel, the cosmetics, and the like. However, the prediction device 100 may use various objects related to the interest of the user, as the interest information. For example, the prediction device 100 may use an object with a limited region, as the interest information. To be specific, the prediction device 100 may use the objects with limited regions such as “weather in Kanto region” and an “event in Osaka”, as the interest information.

5-4. Sensor Information Related to User

In the first embodiment, the prediction device 100 uses the position information of the user, as the sensor information related to the user. In the first embodiment, an example in which the user terminal 10 mainly acquires the position information of the user with a GPS has been described. However, in acquisition of the position information, information that can be acquired with fingerprint of Wi-Fi (registered trademark), Bluetooth (registered trademark), or an infrared ray, i.e., various types of information such as so-called beacon may be used as the position information of the user. Further, the prediction device 100 may use not only the position information of the user, but also various types of information related to the user. For example, the prediction device 100 may use acceleration information of the user, as the sensor information related to the user. In this case, the prediction device 100 acquires the acceleration information of the user detected with an acceleration sensor mounted in the user terminal 10 held by the user. Further, the prediction device 100 may use the number of times of reactions of the position information sensor, or the number of times of reactions of the acceleration sensor, as the sensor information related to the user. Further, the prediction device 100 may use any sensor information as long as the sensor information is related to the user, and for example, may use various types of information such as illumination, temperature, humidity, and sound volume.

5-5. Others

In the first embodiment, the prediction device 100 predicts the interest of the user to be predicted, using the generated user classification. However, the prediction device 100 may generate the user classification from the histories of the position information of the plurality of users including the history of the position information of the user to be predicted. To be specific, the prediction device 100 extracts the plurality of tendency items from the histories of the position information of the plurality of users including the history of the position information of the user to be predicted. The prediction device 100 then generates the user classification, based on the action pattern of each user indicated by the plurality of extracted tendency items. Accordingly, the prediction device 100 can extract the tendency item including the action pattern of the user to be predicted. Further, the prediction device 100 can determine the user classification of the user to be predicted at a point of time when the user classification is generated. Therefore, the prediction device 100 can predict the interest of the user to be predicted, based on the user classification generated including the action pattern of the user to be predicted.

6. Effects

As described above, the prediction device 100 according to the first embodiment includes the acquisition unit 131 and the prediction unit 134. The acquisition unit 131 acquires the sensor information related to the first user detected with the sensor. The prediction unit 134 predicts the interest of the first user, based on the action pattern obtained from the history of the sensor information related to the first user, the sensor information having been obtained by the acquisition unit 131, and the interest information of the user classification into which the second user is classified according to the action pattern obtained from the history of the sensor information related to the second user.

Accordingly, the prediction device 100 according to the first embodiment can appropriately predict the interest of the first user, the interest being the information related to the first user, based on the action pattern obtained from the history of the sensor information of the first user and the action pattern of the user classification.

Further, in the prediction device 100 according to the first embodiment, the prediction unit 134 predicts the user classification in which the first user belongs, based on the action pattern obtained from the history of the sensor information related to the first user, and the action pattern obtained from the history of the sensor information related to the second user.

Accordingly, the prediction device 100 according to the first embodiment can appropriately predict the user information to which the user belongs, based on the action pattern obtained from the history of the sensor information of the user and the action pattern of the user classification.

Further, the prediction device 100 according to the first embodiment includes the extraction unit 133. The extraction unit 133 extracts the tendency item into which the content of each sensor information included in the histories is classified, and which indicates the tendency of the actions of the second user group, based on the histories of the sensor information related to the second user group, and extracts the sensor information corresponding to each of the plurality of tendency items from the history of the sensor information of each of a plurality of other users. Further, the prediction unit 134 predicts the interest of the first user, using the interest information of each user classification into which the second user is classified, based on the distribution of the sensor information corresponding to each of the plurality of tendency items extracted by the extraction unit 133.

Accordingly, the prediction device 100 according to the first embodiment can appropriately predict the interest of the first user, by using the user classification based on the distribution of the sensor information corresponding to each of the plurality of tendency items indicating the tendency of the action of the first user.

Further, in the prediction device 100 according to the first embodiment, the extraction unit 133 extracts the sensor information corresponding to each of the plurality of tendency items from the history of the sensor information of the first user. Further, the prediction unit 134 predicts the interest of the first user from the interest information of the user classification into which the first user is classified, based on the degree of similarity between the distribution of the sensor information corresponding to each of the plurality of tendency items in the first user, the sensor information having been extracted by the extraction unit 133, and the distribution of the sensor information corresponding to each of the plurality of tendency items associated with each user classification.

Accordingly, the prediction device 100 according to the first embodiment can appropriately predict the interest of the first user, by classifying the first user, based on the degree of similarity between the distribution of the sensor information corresponding to each of the plurality of tendency items of the first user, and the distribution of the sensor information corresponding to each of the plurality of tendency items associated with each user classification.

Further, in the prediction device 100 according to the first embodiment, the extraction unit 133 extracts the interest information of the user classification from the interest information of the second user classified into the user classification.

Accordingly, the prediction device 100 according to the first embodiment can appropriately predict the interest of the first user, by using the interest information of the user classification based on the interest information of the second user classified into the user classification.

Further, in the prediction device 100 according to the first embodiment, the acquisition unit 131 acquires the position information of the first user detected with the sensor, as the sensor information of the first user. The prediction unit 134 predicts the interest of the first user, based on the action pattern obtained from the history of the position information of the first user obtained by the acquisition unit 131, and the interest information of the user classification into which the second user is classified according to the action pattern obtained from the history of the position information of the second user.

Accordingly, the prediction device 100 according to the first embodiment can appropriately predict the interest of the first user, based on the action pattern obtained from the history of the position information of the first user and the action pattern of the user classification.

### Second Embodiment

1. Prediction Processing

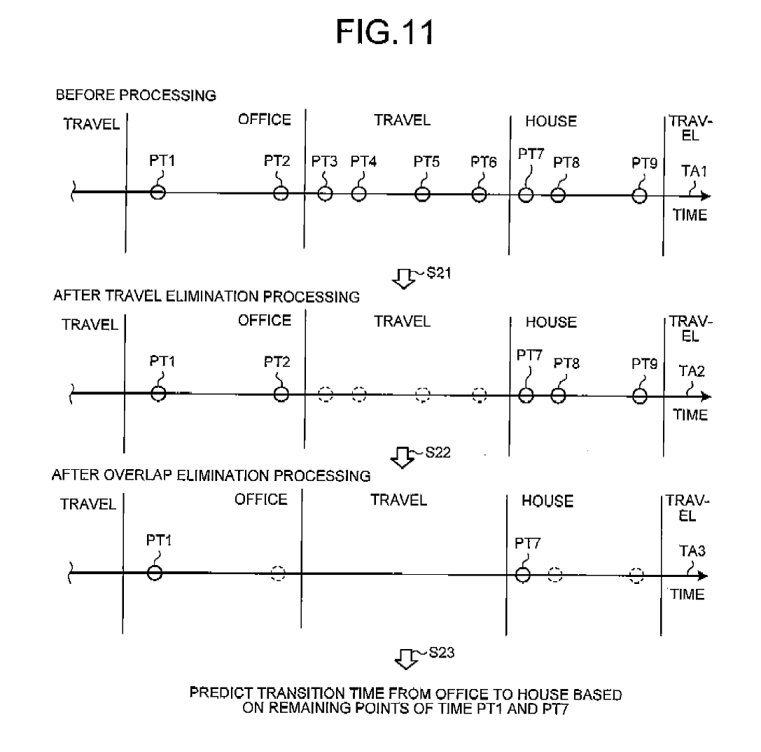

First, an example of prediction processing according to a second embodiment will be described using FIG. 11. FIG. 11 is a diagram illustrating an example of prediction processing according to the second embodiment. A prediction device 200 predicts a time from a predetermined time when a user is positioned in a starting point that is one stay point to a predetermined time when the user is positioned in a destination that is another stay point, of a plurality of stay points of the user included in position information of the user, as a prediction time. In the present embodiment, the prediction device 200 predicts a time obtained by adding a stay time in the starting point and a travel time from the starting point to the destination, as the prediction time. In other words, the prediction device 200 predicts a time (hereinafter, may be referred to as “transition time”) from a point of time when the user is supposed to arrive at the starting point to a point of time when the user is supposed to arrive at the destination that is the other stay point, as the prediction time. That is, the prediction device 200 predicts the time from the point of time when the user is supposed to arrive at the starting point to the point of time when the user is supposed to arrive at the destination, as information related to the user. In the example illustrated in FIG. 11, a case will be described, in which a time from a point of time when the user arrives at an office to a point of time when the user is supposed to arrive at a house, where the office is the starting point and the house is the destination, of a plurality of stay points.

On a time axis TA1 in FIG. 11, position information from which position information of the user has been acquired, that is, points of time PT1 to PT9 corresponding to position information before processing are illustrated. Here, the position information corresponding to the points of time PT1 and PT2 illustrated in FIG. 11 is position information acquired in the points of time when the user is positioned in the user, the position information corresponding to the points of time PT3 to PT6 is position information acquired in the points of time when the user travels, and the position information corresponding to the points of time PT7 to PT9 is position information acquired in the points of time when the user is positioned in the house. That is, the office where the user is positioned at the points of time PT1 and PT2 and the house where the user is positioned at the points of time PT7 to PT9 are stay points of the user predicted by the prediction device 200. Note that details of extraction of the stay points by the prediction device 200 will be described below.

First, the prediction device 200 eliminates the position information related to travel of the user from the position information before processing (step S21). In the example illustrated in FIG. 11, the position information related to the travel corresponding to the points of time PT3 to PT6 is eliminated. Accordingly, on a time axis TA2 after travel elimination processing in FIG. 11, the points of time PT1 and PT2 corresponding to the position information of the office that is the stay point, and the points of time PT7 to PT9 corresponding to the position information of the house that is the stay point remain. Note that details of the elimination of the position information related to the travel by the prediction device 200 will be described below.

First, the prediction device 200 eliminates overlapping position information in each stay point from the position information after the travel elimination processing (step S22). To be specific, the prediction device 200 eliminates the position information except the position information corresponding to the earliest point of time in each stay point. In the example illustrated in FIG. 11, the position information corresponding to the point of time PT2 and the points of time PT8 and PT9 is eliminated. Accordingly, on a time axis TA3 after overlap elimination processing in FIG. 11, the point of time PT1 corresponding to the position information acquired at the earliest point of time in the office as the stay point, and the point of time PT7 corresponding to the position information acquired at the earliest point of time in the house as the stay point remain.

Following that, the prediction device 200 predicts the transition time from the time of the office to the time of arrival to the house, based on the remaining points of time PT1 and PT7 (step S23). To be specific, the prediction device 200 predicts the time from the point of time when the user arrives at the office to the point of time when the user is supposed to arrive at the house, by obtaining a time difference between the point of time PT1 and the point of time PT7.

As described above, the prediction device 200 according to the second embodiment can predict the time from the point of time when the use is supposed to arrive at the starting point that is one Stay point to the point of time when the user is supposed to arrive at the destination that is the other stay point, based on a history of the position information of the user. In FIG. 11, an example has been described, in which the time from the point of time when the user arrives at the office to the point of time when the user is supposed to arrive at the house is predicted by obtaining the time difference of the pair of the point of time PT1 and the point of time PT7. However, the time from when the user arrives at a certain starting point to when the user arrives at the destination can be more appropriately predicted by obtaining an average of time differences among a plurality of pairs of the points of time. Further, in FIG. 11, an example in which the transition time from the office to the house is predicted has been described. However, when a plurality of the stay points has been predicted, the prediction device 200 can predict the transition times among the stay points by having each stay point as the starting point, and the other stay points as the destination. That is, in a case where the user is positioned in a predetermined stay point, the prediction device 200 can predict which timing and which stay point of the other stay points the user will make a transition. For example, when the prediction device 200 has acquired the position information from the user terminal 11 of the user, the prediction device 200 can predict when and where the user will travel next, from the position information and the time when the position information has been acquired. Further, when the prediction device 200 has acquired the position information indicating that the user is positioned in a certain stay point, by use of a transition probability described below that indicates which destination the user makes a transition from the starting point, the prediction device 200 can predict where and which probability the user will travel, and how long the transition time is when the travel is performed, using the time when the position information has been acquired as the starting point. That is, the prediction device 200 can predict where and which timing the user will travel in the future. Further, since the prediction device 200 can predict the next transition, the prediction device 200 can predict the action of the user in a chain manner. Therefore, the prediction device 200 can predict the action of the user during a predetermined period (for example, one day). As described above, the prediction device 200 can predict the action of the user during the predetermined, that is, a schedule. Therefore, for example, in a case where the prediction by the prediction device 200 is used for content distribution, appropriate content can be distributed to the user at appropriate timing.

Conventionally, a technology for determining the travel of the user, and the time required for the travel, based on the history of the position information of the user acquired at short intervals (hereinafter, may be referred to as “history of dense position information”) has been provided. Further, a technology for predicting the next stay point, based on the position information of the user acquired at short intervals has been provided. Accordingly, the time required for the user to travel to the next stay point can be predicted. However, in such conventional technologies, the travel is determined upon the start of the travel by the user, and the time required for the travel is predicted. Therefore, it is difficult to predict, in advance, a time of movement of the position of the user from the starting point that is the current stay point to the destination that is the next stay point. Further, even when the user starts traveling, the time required for the travel differs depending on the destination. Therefore, it is difficult to predict, in advance, the time of movement of the position of the user from the starting point to the destination.

The prediction device 200 according to the second embodiment predicts a time from the point of time when the user is supposed to arrive at the starting point that is one stay point to the point of time when the user is supposed to arrive at the destination that is another stay point, based on the history of the position information of the user. That is, the prediction device 200 can predict the transition time between the stay points in advance, based on the history of the position information of the user. To be specific, when the position information acquired from the user is one stay point, the prediction device 200 can predict the transition time to another stay point, by supposing the point of time when the position information has been acquired, as the point of time when the user has arrived at the stay point. Further, the prediction device 200 respectively predicts the transition time from the starting point to the destinations. That is, the prediction device 200 can predict the time to stay in the starting point that is the stay point where the user is currently positioned, for each of the destinations. Further, when the position information acquired from the user is one stay point, the prediction device 200 can predict the transition time from the stay point to another stay point, and can further predict the transition time from the another stay point to other stay point. In other words, when the position information acquired from the user is one stay point, the prediction device 200 can predict what kind of travel the user will perform in the future, including time.

Further, the prediction device 200 according to the second embodiment can predict the transition time from the starting point to the destination, based on the history of the intermittently and randomly acquired position information of the user (hereinafter, may be referred to as “history of coarse position information”, even if the position information of the user cannot be acquired at short intervals, and is intermittently and randomly acquired. To be specific, the prediction device 200 can predict the transition time between stay points by integrating the transition times among the points of time extracted from the history of the coarse position information, and using each stay point as the starting point and another stay point as the destination. As described above, the prediction device 200 can predict the transition time from the starting point to the destination, even if the history of the position information of the user is the history of the dense position information or the history of the coarse position information. In the above example, the time obtained by adding the stay time in the starting point, and the travel time from the starting point to the destination has been predicted as the prediction time. However, a time obtained by adding the stay time in the destination, and the travel time from the starting point to the destination may be predicted as the prediction time. In this case, in the above example, a time from when the user departs from the office to the point of time when the user is supposed to depart the house, by obtaining a time difference between the point of time PT2 when the user stays the office and the point of time PT9 when the user stays in the house. Accordingly, the prediction device 200 can predict the action of the user during a predetermined period, that is, a schedule such as when and where the user will start traveling. Therefore, in a case where the prediction by the prediction device 200 is used for distribution of content, appropriate content can be distributed to the user at appropriate timing. Further, the predetermined time when the user is positioned in the starting point that is one stay point, or the predetermined time when the user is positioned in the destination that is another stay point may be a middle of the time when the user is positioned in the stay point, may be a middle time of consecutive pieces of position information in the same stay point, or may be an average of times of the consecutive pieces of position information in the same stay point.

2. Configuration of Prediction System

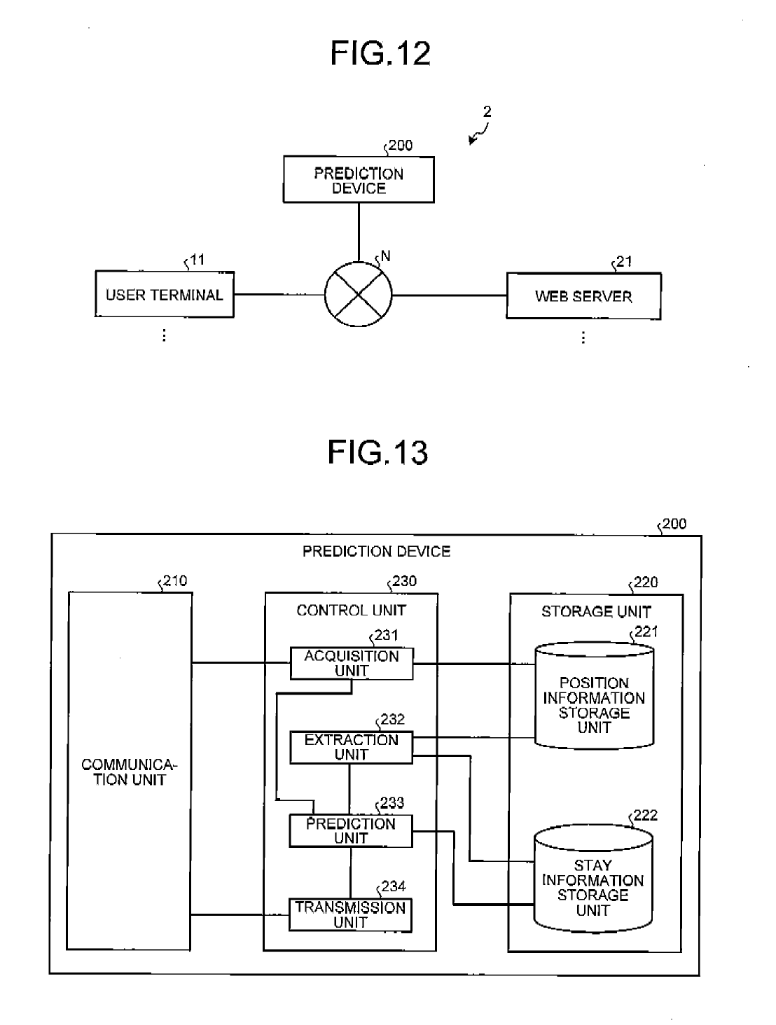

Next, a configuration of the prediction system 2 according to the second embodiment will be described using FIG. 12. FIG. 12 is a diagram illustrating a configuration example of the prediction system 2 according to the second embodiment. As illustrated in FIG. 12, the prediction system 2 includes a user terminal 11, a web server 21, and the prediction device 200. The user terminal 11, the web server 21, and the prediction device 200 are communicatively connected by wired or wireless means through a network N. Note that the prediction system 2 illustrated in FIG. 12 may include a plurality of the user terminals 11, a plurality of the web servers 21, and a plurality of the prediction devices 200.

The user terminal 11 is an information processing device used by the user. The user terminal 11 according to the second embodiment is a mobile terminal such as a smart phone, a tablet terminal, or a personal digital assistant (PDA), and detects the position information with a sensor. For example, the user terminal 11 includes a position information sensor with a global positioning system (GPS) transmission/reception function to communicate with a GPS satellite, and acquires the position information of the user terminal 11. Note that the position information sensor of the user terminal 11 may acquire the position information of the user terminal 11, which is estimated using the position information of a base station that performs communication, or a radio wave of wireless fidelity (Wi-Fi (registered trademark)). Further, the user terminal 11 may estimate the position information of the user terminal 11 by combination of the above-describe position information. Further, the user terminal 11 may use not only the GPS but also various sensors as long as the user terminal 11 can acquire traveling speed and distance with the sensors. For example, the user terminal 11 may acquire the traveling speed with an acceleration sensor. Further, the user terminal 11 may calculate the traveling distance by a function to count the number of steps like a pedometer. For example, the user terminal 11 may calculate the traveling distance with the number of count of the pedometer and a supposed step of the user. The user terminal 11 transmits the above information to the prediction device 100, and may perform the above calculation by the prediction device 100. Further, the user terminal 11 transmits the acquired position information to the web server 21 and the prediction device 200.

The web server 21 is an information processing device that provides content such as a web page in response to a request from the user terminal 11. When the web server 21 acquires the position information of the user from the user terminal 11, the web server 20 transmits the history of the position information of the user of the user terminal 11 to the prediction device 200.

The prediction device 200 predicts a plurality of stay points of the user, based on the acquired history of the position information of the user, and predicts the time from the point of time when the user is supposed to arrive at the starting point that is one stay point to the point of time when the user is supposed to arrive at the destination that is another stay point, of the plurality of stay points.

Here, an example of the processing of the prediction system 2 will be described. When the prediction device 200 has acquired the history of the position information of the user from the web server 21, for example, the prediction device 200 predicts the plurality of stay points of the user, and predicts the time from the point of time when the user is supposed to arrive at the starting point that is one stay point to the point of time when the user is supposed to arrive at the destination that is another stay point, of the plurality of stay points. When the prediction device 200 has received the predicted position information of the user from the web server 21, the prediction device 200 transmits, to the web server 21, information related to the transition time from the stay point to the another stay point corresponding to the predicted position information of the user. The web server 21 then supplies content to the user at appropriate timing, based on the transition time of the user acquired from the prediction device 200. Note that the prediction device 200 and the web server 21 may be integrated.

3. Configuration of Prediction Device

Next, a configuration of the prediction device 200 according to the second embodiment will be described using FIG. 13. FIG. 13 is a diagram illustrating a configuration example of the prediction device 200 according to the second embodiment. As illustrated in FIG. 13, the prediction device 200 includes a communication unit 210, a storage unit 220, and a control unit 230.

The communication unit 210 is realized by an NIC, or the like. The communication unit 210 is connected with the network N by wired or wireless means, and transmits/receives information to/from the user terminal 11 and the web server 21.

Storage Unit 220

The storage unit 220 is realized by a semiconductor memory device such as random access memory (RAM) or flash memory, or a storage device such as a hard disk or an optical disk. The storage unit 220 according to the second embodiment includes, as illustrated in FIG. 13, a position information storage unit 221 and a stay information storage unit 222.

Position Information Storage Unit 221

The position information storage unit 221 according to the second embodiment stores the position information of the user acquired from the use terminal 11, for example. FIG. 14 illustrates an example of the position information of the user stored in the position information storage unit 221. As illustrated in FIG. 14, the position information storage unit 221 includes items such “date and time”, “latitude”, and “longitude”, as the position information.

The “date and time” indicates date and time when the position information has been acquired. For example, as the “date and time”, the date and time when the position information has been acquired with a position information sensor of the user terminal 11 is used. Further, the “latitude” indicates latitude of the position information. The “longitude” indicates longitude of the position information. For example, the position information storage unit 221 stores the position information acquired in the date and time “2014/04/01 0:35:10”, and having the latitude of “35.521230” and the longitude of “139.503099”, and the position information acquired in the date and time “2014/04/01 7:20:40”, and having the latitude of “35.500612” and the longitude of “139.560434”.

Stay Information Storage Unit 222

The stay information storage unit 222 according to the second embodiment stores a transition model that indicates a transition probability and a transition time between the stay points, the transition model being stay information of the user. Note that the transition probability indicates a probability that the user travels from one stay point to a corresponding stay point of the other stay points. For example, when the transition probability is “0.4” of when the starting point is the “house” and the destination is the “office”, this indicates that the probability to travel from the house to the office of the other stay points is 40%.

FIG. 15 illustrates an example of the stay information of the user stored in the stay information storage unit 222. As illustrated in FIG. 15, the stay information storage unit 222 stores the transition model divided in each day of week/holiday and time, as the stay information of the user.

In the example illustrated in FIG. 15, the transition model based on the position information of the user acquired during the hour from 0:00 to 0:59 on Monday is stored in “0:00 of Monday (transition probability/transition time)”. The transition model based on the position information of the user acquired during the hour from 23:00 to 23:59 on a holiday is stored in “23:00 of holiday (transition probability/transition time)”. As described above, the transition model is stored for each of the days of week/holiday “Mon, Tue, Wed, Thu, Fri, Sat, Sun, and holiday” and the times “0:00 to 23:00”. To be specific, the transition model is stored for each of “0:00 on Monday”, “1:00 on Monday”, “2:00 on Monday”, “3:00 on Monday” . . . “22:00 on holiday”, and “23:00 on holiday”. Therefore, in the example illustrated in FIG. 15, the stay information storage unit 222 stores 192 transition models corresponding to each of the days of week/holiday and the times.

In the example illustrated in FIG. 15, the column illustrated in the “starting point” corresponds to “house”, “office”, “other 0” . . . “other n”, which are the stay points serving as the starting points. In the row illustrated in the “destination” corresponds to “house”, “office”, “other 0” . . . “other n”, which are the stay points serving as the destinations. For example, in the transition model of “0:00 on Monday”, “0.75/10.5” in which the “starting point” corresponds to the “house” and the “destination” corresponds to the “office” indicates the transition probability and the transition time from the house to the office during the hour from 0:00 to 0:59 on Monday. To be specific, when the user is supposed to arrive at the house during the hour from 0:00 to 0:59 on Monday, the “0.75/10.5” indicates the transition time from the point of time to the office and the transition probability. That is, the “0.75/10.5” in which the “starting point” corresponds to the “house” and the “destination” corresponds to the “office” in the transition model of “0:00 on Monday” indicates that the transition time from the house to the office is 10.5 hours, and the probability to travel to the office is 75%, when the user is supposed to arrive at the house during the hour from 0:00 to 0:59 on Monday. Further, “0.9/10” in which the “starting point” corresponds to the “house” and the “destination” corresponds to the “office” in the transition model of “23:00 on holiday” indicates that the transition time from the house to the office is 10 houses, and the probability to travel to the office is 90%, when the user is supposed to arrive at the house during the hour from 23:00 to 23:59 on a holiday.

Control Unit 230

Referring back to the description of FIG. 13, the control unit 230 is realized by execution of various programs (corresponding to examples of the prediction program) stored in a storage device inside the prediction device 200, by a CPU, an MPU, or the like, using RAM as a work area. Further, the control unit 230 is realized by an integrated circuit such as an ASIC or an FPGA.

As illustrated in FIG. 13, the control unit 230 includes an acquisition unit 231, an extraction unit 232, a prediction unit 233, and a transmission unit 234, and realizes or executes functions and actions of information processing described below. Note that the internal configuration of the control unit 230 is not limited to the configuration illustrated in FIG. 13, and may be another configuration as long as the configuration performs the information processing described below. Further, connection relationship of the processing units included in the control unit 230 is not limited to the connection relationship illustrated in FIG. 13, and may be another connection relationship.

Acquisition Unit 231

The acquisition unit 231 acquires the position information of the user. When the acquisition unit 231 has acquired the history of the position information of the user to be predicted, the acquisition unit 231 stores the history in the position information storage unit 221.

Extraction Unit 232

When a speed to travel between two points based on two pieces of the position information with consecutive acquired points of time is less than a predetermined threshold, the extraction unit 232 extracts the two pieces of the position information from the history of the position information of the user stored in the position information storage unit 221. Further, the extraction unit 232 extracts the position information with the earliest acquired point of timer of the plurality of pieces of position information having the consecutive acquired points of time, and having a distance between points based on the consecutive pieces of the position information being less than a threshold, from the history of the position information of the user extracted by the extraction unit 232. Note that the processing of extracting the two pieces of the position information from the history of the position information of the user when the speed to travel between two points based on two pieces of the position information with consecutive acquired points of time is less than a predetermined threshold by the extraction unit 232 corresponds to the travel elimination processing on the time axis TA2 illustrated in FIG. 11, and thus is hereinafter referred to as travel elimination processing. Further, the processing of extracting the position information with the earliest acquired point of time, of the plurality of pieces of position information having the consecutive acquired points of time, and having a distance between points based on the consecutive pieces of the position information being less than a threshold, from the history of the position information of the user extracted by the travel elimination processing by the extraction unit 232 corresponds to the overlap elimination processing on the time axis TA3 illustrated in FIG. 11, and thus is hereinafter referred to as overlap elimination processing.

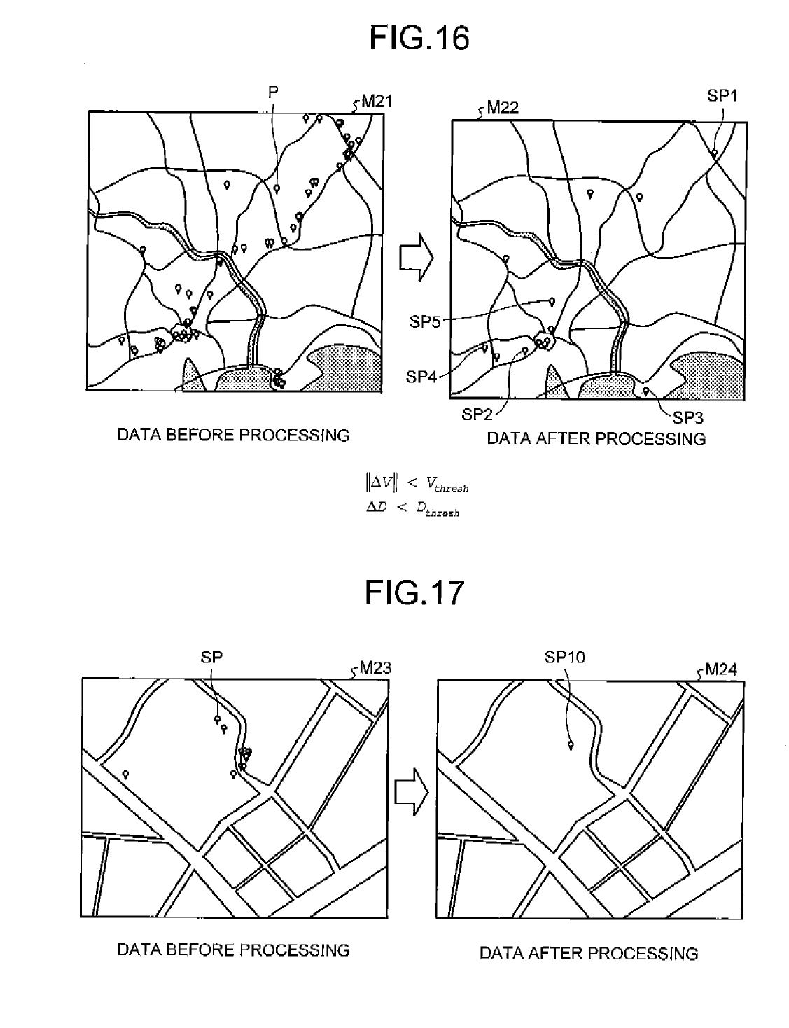

The travel elimination processing and the overlap elimination processing by the extraction unit 232 will be described using FIG. 16. On a map M21 illustrated in FIG. 16, a plurality of points P from which the position information of the user has been acquired is illustrated. Note that P is attached to only one point on the map M21 illustrated in FIG. 16, and P is omitted in other points. First, the extraction unit 232 eliminates the point P estimated to be the position information in traveling, from the points P on the map M21 by the travel elimination processing. Note that the extraction unit 232 may calculate the distance between two points based on the consecutive pieces of position information, from the longitude and the latitude of the two points by various technique such as Hubeny's simplified formula. The extraction unit 232 calculates the speed to travel between the two points based on the calculated distance (the speed≧0). In the example illustrated in FIG. 16, the extraction unit 232 calculates the norm of the speed ΔV to travel between the two points based on the calculated distance. The extraction unit 232 then extracts the two points, when the norm of the speed ΔV to travel between the two points is less than a predetermined threshold Vₜₕᵣₑₛₕ. In the example illustrated in FIG. 11, the position information corresponding to the point of time PT1 and the position information corresponding to the point of time PT2 are extracted. Further, in the example illustrated in FIG. 11, the position information corresponding to the point of time PT7, the position information corresponding to the point of time PT8, and the position information corresponding to the point of time PT9, that is, the pieces of position information respectively corresponding to the points of time PT7, PT8, and PT9 are extracted. Accordingly, in the example illustrated in FIG. 11, the pieces of position information respectively corresponding to the points of time PT3 to PT6, which are estimated to be traveling, are eliminated. On the map M21 illustrated in FIG. 16, the plurality of points P that is consecutively positioned in the central portion on the map in an oblique manner from a right upper portion to a lower left portion is eliminated as the points P corresponding to the position information in traveling.

The extraction unit 232 eliminates the position information except the position information with the earliest acquired point of time, of the plurality of pieces of position information having the distance between points based on the position information with the consecutive acquired points of time being less than the threshold, from the points P on the map M21 after the travel elimination processing by the overlap elimination processing. To be specific, the extraction unit 232 extracts the position information with the earliest acquired point of time, of the plurality of pieces of position information with the consecutive acquired points of time, and having the distance ΔD of being less than the predetermined threshold Dₜₕᵣₑₛₕ, the distance ΔD being the distance between the two points calculated as described above (hereinafter, the plurality of pieces of position information may be referred to as “consecutive position information group”). In the example illustrated in FIG. 11, the position information corresponding to the point of time PT1, of the position information corresponding to the point of time PT1 and the position information corresponding to the point of time PT2 included in the same consecutive position information group, is extracted. Further, in the example illustrated in FIG. 11, the position information corresponding to the point of time PT7, of the pieces of position information respectively corresponding to the points of time PT7, PT8, and PT9 included in the same consecutive position information group, is extracted. Accordingly, in the example illustrated in FIG. 11, the pieces of position information respectively corresponding to the points of time PT2, PT8, and PT9, other than the points of time PT1 and PT7 corresponding to the position information with the earliest acquired point of time, are eliminated.

On a map M22 illustrated in FIG. 16, the points corresponding to the position information in the history that includes the earliest position information of each stay point, the earliest position information having been extracted by the travel elimination processing and the overlap elimination processing by the extraction unit 232, are illustrated. Therefore, these points serve as the stay points of the user extracted by the extraction unit 232. For example, a plurality of stay points such as stay points SP1 to SP5 is illustrated on the map M22 of FIG. 16.

Here, the extraction unit 232 may treat adjacent stay points as the same stay point. This point will be described using FIG. 17. FIG. 17 is a diagram illustrating an example of stay point integration. A map M23 of FIG. 17 illustrates stay points before May point integration, and a plurality of stay points SP is illustrated. Note that SP is attached to only one stay point on the map M23 illustrated in FIG. 17, and SP is omitted in other stay points. For example, a plurality of adjacent stay points SP on the map M23 illustrated in FIG. 17 may be treated as the same stay point. Further, for example, the extraction unit 232 may integrate the positions of the adjacent stay points as the same stay point. As for the positions of the plurality of adjacent stay points SP on the map M23 illustrated in FIG. 17, the plurality of stay points may be put together and integrated to one position. In this case, an average of the positions of the plurality of adjacent stay points SP may be employed as the position of the stay point after the integration. A map M24 of FIG. 17 illustrates the stay point after the integration of the plurality of adjacent stay points SP. In the example illustrated in FIG. 17, the plurality of adjacent stay points SP is integrated into a stay point SP10. In this case, the positions (the longitude and the latitude) of the position information corresponding to the plurality of stay points SP in the example illustrated in FIG. 17 becomes the position (the longitude and the latitude) illustrated in the stay point SP10. For example, the extraction unit 232 may have the number of stay points up to 25 for one user. When the time obtained by adding the stay time in the destination, and the travel time from the starting point to the destination is predicted as the prediction time, the extraction unit 232 may eliminate the position information except the position information with the last acquired point of time, of the plurality of pieces of position information having the consecutive acquired points of time, and having a distance between points based on the position information being less than a threshold, by the overlap elimination processing. That is, the extraction unit 232 may eliminate the position information except the position information with the last acquired point of time, from the consecutive position information group. Further, the extraction unit 232 may acquire intermediate position information from the consecutive position information group, depending on the intended use, or may extract an average time and position from the entire consecutive position information group. Note that a condition to determine what kind of position information is extracted from the consecutive position information group by the overlap elimination processing may be unified.

Prediction Unit 233

The prediction unit 233 predicts, as the prediction time, a time from a predetermined time when the user is positioned in the starting point that is one stay point to a predetermined time when the user is positioned in the destination that is another stay point, of the plurality of stay points of the user extracted based on the history of the position information of the user acquired by the acquisition unit 231. To be specific, the prediction unit 233 predicts the time obtained by adding the stay time in the starting point or the stay time in the destination, and the travel time from the starting point to the destination, as the prediction time. For example, the prediction unit 233 predicts the transition time among the plurality of stay points of the user extracted by the extraction unit 232. Further, the prediction unit 233 predicts the probability to travel from the starting point to the destination, based on the history of the position information of the user. For example, the prediction unit 233 predicts the transition probability among the plurality of stay points of the user extracted by the extraction unit 232.

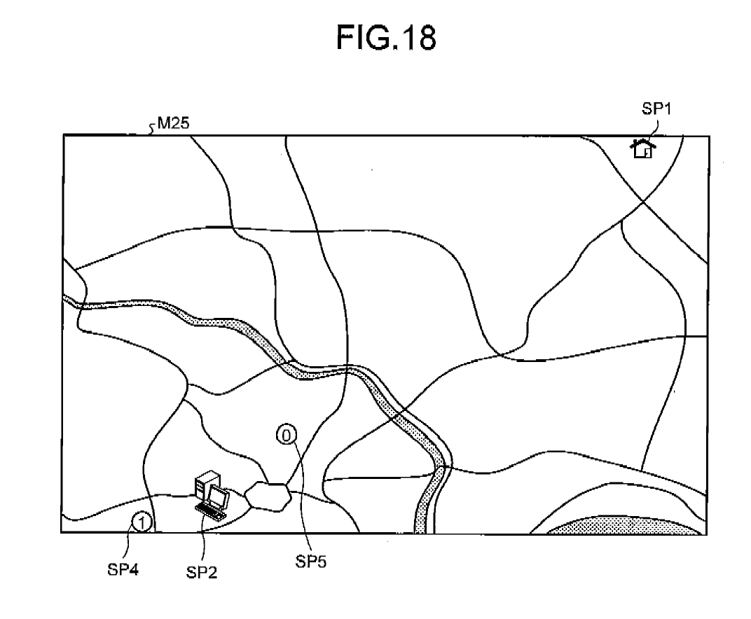

First, prediction of a role of the stay point by the prediction unit 233 will be described using FIG. 18. The prediction unit 233 predicts a role of the stay point extracted by the extraction unit 232. The prediction unit 233 may predict the role of the stay point, based on a time zone where 3:00 to 7:00 is early morning, 7:00 to 10:00 is morning, 10:00 to 14:00 is noon, 14:00 to 18:00 is afternoon, 18:00 to 22:00 is night, and 22:00 to 3:00 is midnight. Note that the above-described X:00 to Y:00 means from X:00 to Y:00, exclusive of Y:00. For example, the prediction unit 233 may estimate the stay point of the user where the position information is acquired in the midnight (22:00 to 3:00) and the early morning (3:00 to 7:00), as the house of the user. Further, the prediction unit 233 may estimate the stay point of user where the position information is acquired on a holiday, as the house of the user. Further, for example, the prediction unit 233 may estimate the stay point of the user where the position information is acquired in the daytime (10:00 to 18:00) on a weekday, as the office of the user. Which position being which role may be estimated by appropriately using various conventional technologies. On a map M25 illustrated in FIG. 18, the stay point SP1 is estimated as the “house” of the user, the stay point SP2 is estimated as the “office” of the user, the stay point SP5 is estimated as the stay point “other 0”, and the stay point SP4 is estimated as the stay point “other 1”. The prediction unit 233 may number the stay points “other” in an order where the point of time when the corresponding position information is acquired is closer to the present time. In this way, the prediction unit 233 predicts the role of each stay point.

Further, the prediction unit 233 generates the transition model that indicates the transition probability and the transition time among the plurality of stay points in order to predict the transition time between the stay points. For example, the prediction unit 233 generates the transition model for each of the days of week/holiday “Mon, Tue, Wed, Thu, Fri, Sat, Sun, and holiday” and the time “0:00 to 23:00”, based on the history including the earliest position information extracted by the extraction unit 232. To be specific, the prediction unit 233 generates the transition model of each of “0:00 on Monday”, “1:00 on Monday”, “2:00 on Monday”, “3:00 on Monday” . . . “22:00 on holiday”, and “23:00 on holiday”. Therefore, in the example illustrated in FIG. 15, the prediction unit 233 generates 192 transition models corresponding to the respective days of week/holiday and times. Further, the prediction unit 233 stores the generated transition models in the stay information storage unit 222. Note that the above-described transition models are examples, and the prediction unit 233 may appropriately generate the transition models divided in a predetermined condition, depending on the intended use. For example, the prediction unit 233 may generate the transition model for each of “weekdays/holiday” and the times “0:00 to 23:00”. Further, the prediction unit 233 may generate the transition model for each of the days of week “Mon, Tue, Wed, Thu, Fri, Sat, Sun, and holiday” and time zones “morning, afternoon”.

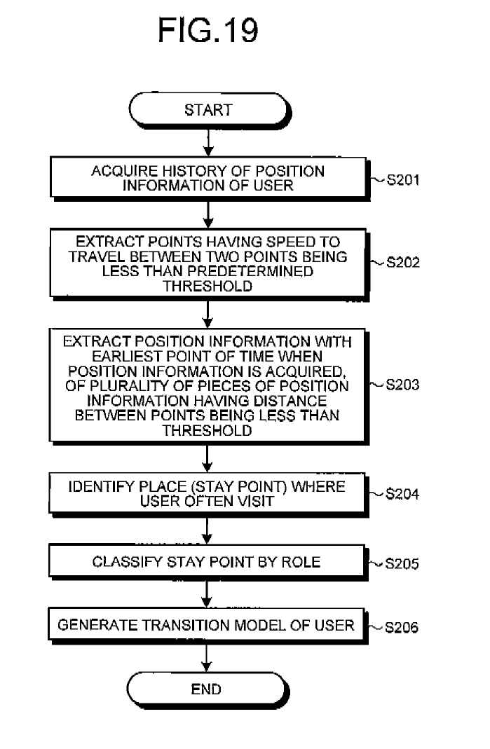

Here, a process of processing up to the generation of the transition model in the prediction processing will be described using FIG. 19. FIG. 19 is a flowchart illustrating a process of the processing up to the generation of the transition model in the prediction processing according to the second embodiment. First, the acquisition unit 231 acquires the history of the position information of the user (step S201). The acquisition unit 231 may store the intermittently and randomly acquired position information of the user to the position information storage unit 221, and use the position information as the history of the position information of the user.

Next, the extraction unit 232 extracts the points having the speed of traveling between two consecutive points being less than the predetermined threshold, based on the history of the position information of the user (step S202). That is, the extraction unit 232 performs the travel elimination processing, and eliminates the points estimated to be the position information in traveling. Following that, the extraction unit 232 extracts the position information with the earliest point of time when the position information has been acquired, of the plurality of pieces of position information having the distance between points where the position information has been consecutively acquired being less than a threshold (step S203). That is the extraction unit 232 performs the overlap elimination processing, and eliminates the position information except the position information with the earliest acquired point of time, of the plurality of pieces of position information having the distance between points based on the position information with the consecutive acquired points of time being less than the threshold. The extraction unit 232 then identifies a place (stay point) where the user often visits, based on the history of the extracted position information (step S204).

Following that, the prediction unit 233 classifies the stay point by role (step S205). To be specific, the prediction unit 233 predicts the role of the stay point extracted and identified by the extraction unit 232. The prediction unit 233 then generates the transition model of the user (step S206). To be specific, the prediction unit 233 generates the transition model that indicates the transition probability and the transition time among the plurality of stay points of the user.

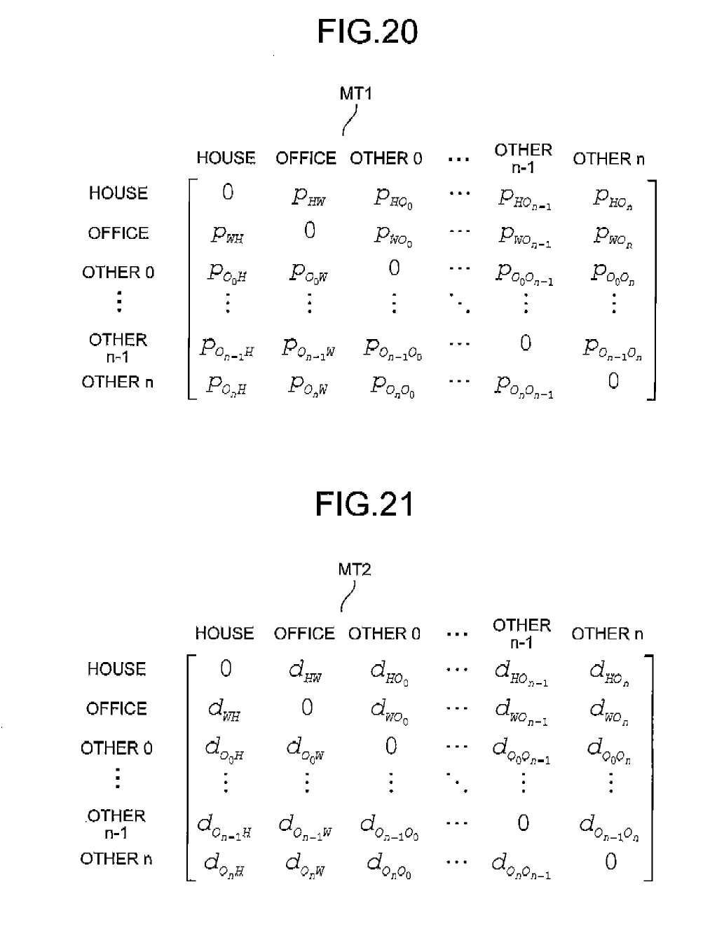

Here, the transition model used by the prediction unit 233 in the prediction processing will be described as a concept of matrix, using FIGS. 20 to 23. FIG. 20 is a diagram illustrating an example of the transition probabilities in the transition model. To be specific, FIG. 20 illustrates the transition probabilities in the transition model in a format of matrix. A matrix MT1 illustrated in FIG. 20 illustrates the transition probabilities among the “house”, the “office”, the “other 0”, . . . the “other n−1”, and the “other n”, which are the stay points. For example, a first-row and second-column component P_{HW} of the matrix MT1 indicates the transition probability from the house to the office. For example, in the example illustrated in FIG. 15, in the transition model of “0:00 on Monday” where the “starting point” corresponds to the “house” and the “destination” corresponds to the “office”, the transition probability is “0.75”.

FIG. 21 is a diagram illustrating an example of the transition times in the transition model. To be specific, FIG. 21 illustrates the transition times in the transition model in a format of matrix. A matrix MT2 illustrated in FIG. 21 illustrates the transition times among the “house”, the “office”, the “other 0”, . . . the “other n−1”, and the “other n”, which are the stay points. For example, a second-row and first-column component d_{WH} in the matrix MT2 indicates the transition time from the office to the house. For example, in the example illustrated in FIG. 15, in the transition model of “0:00 on Monday” where the “starting point” corresponds to the “office” and the “destination” corresponds to the “house”, the transition time is “7”.

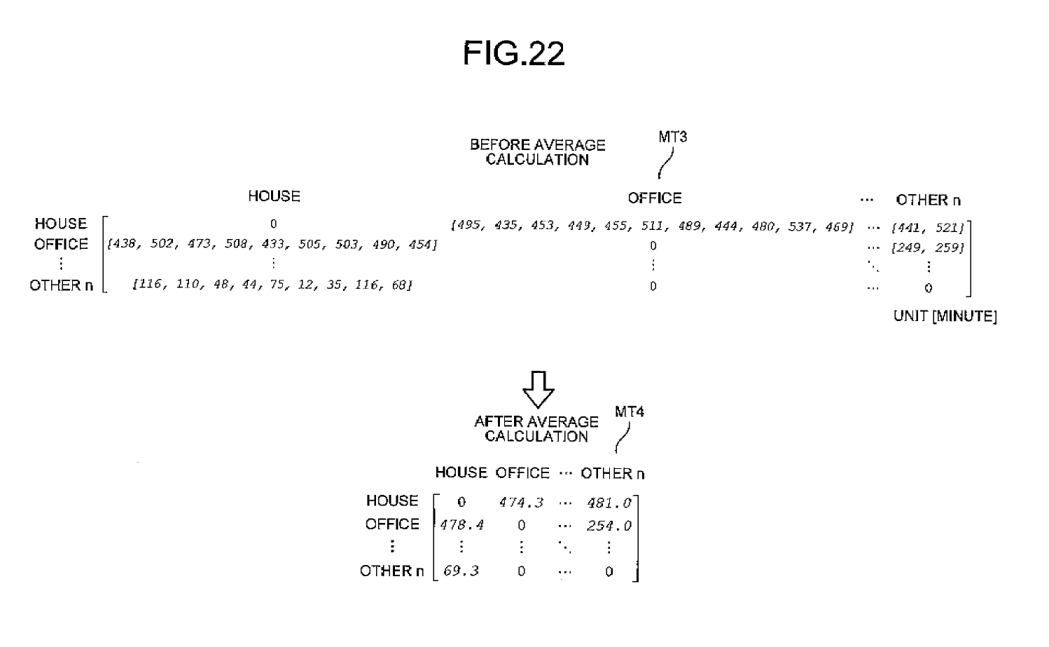

FIG. 22 is a diagram illustrating an example of calculation of the transition time in the transition model. A matrix MT3 in FIG. 22 indicates a matrix of a transition time before average calculation, and a matrix MT4 indicates a matrix of a transition time after average calculation. As illustrated in the matrix MT3 in FIG. 22, for example, a plurality of transition times having the “starting point” corresponding to the “house” and the “destination” corresponding to the “office” is acquired. In the example illustrated in the matrix MT3 of FIG. 22, the transition times having the “starting point” corresponding to the “office” and the “destination” corresponding to the “house” include nine transition times of “438 (minutes)”, “502 (minutes)”, “473 (minutes)”, “508 (minutes)”, “433 (minutes)”, “505 (minutes)”, “503 (minutes)”, “490 (minutes)”, and “454 (minutes)”. Therefore, the prediction unit 233 calculates the transition time having the “starting point” corresponding to the “office” and the “destination” corresponding to the “house” to be “478.4 (minutes)”, which is an average of the nine transition times. Accordingly, the prediction unit 233 generates the matrix MT4 of the transition times after average calculation from the matrix MT3 of the transition times before average calculation.

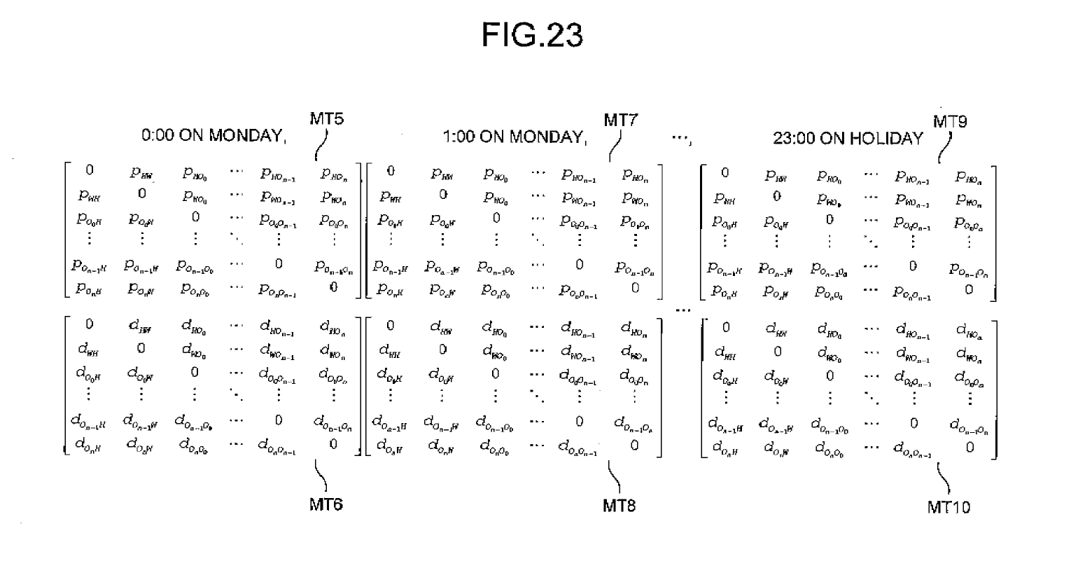

FIG. 23 is a diagram illustrating an example of the transition models. To be specific, FIG. 23 illustrates the transition models generated for each of the days of week/holiday “Mon, Tue, Wed, Thu, Fri, Sat, Sun, and holiday” and the times “0:00 to 23:00” in a form of matrix. For example, a matrix MT5 indicates the transition probability in the transition model of “0:00 on Monday”, and a matrix MT6 indicates the transition time in the transition model of “0:00 on Monday”. Further, a matrix MT7 indicates the transition probability in the transition model of “1:00 on Monday”, and a matrix MT8 indicates the transition time in the transition model of “1:00 on Monday”. Further, a matrix MT9 indicates the transition probability in the transition model of “23:00 on holiday”, and a matrix MT10 indicates the transition time in the transition model of “23:00 on holiday”.

Then, the prediction unit 233 selects one transition model, based on the predetermined date and time, from the plurality of transition models generated from the history of the position information of the user, combines the selected transition model with another transition model until the selected transition model satisfies a predetermined condition, and predicts the time from the point of time when the user is supposed to arrive at the starting point to the point of time when the user is supposed to arrive at the destination, based on the selected transition model. That is, the prediction unit 233 combines the selected transition model with another transition model until the selected transition model satisfies the predetermined condition, and predicts, the transition time from the starting point to the destination, based on the selected transition model. The prediction unit 233 uses date and time when the position information of the user has been acquired by the acquisition unit 231, as the predetermined date and time. Further, when the prediction unit 233 has acquired a time to be predicted and a position to be predicted, the prediction unit 233 predicts the transition time to each destination, based on the time to be predicted, using the position to be predicted as the starting point, and the above-described transition model. Following that, the prediction unit 233 generates prediction information, based on the predicted transition time. For example, the prediction unit 233 generates information related to the transition probability and the transition time to each destination, as the prediction information, using the stay point corresponding to the position to be predicted as the starting point, and another stay point as the destination. Further, the prediction unit 233 may generate information related to the transition time having the stay point corresponding to the position to be predicted as the starting point, and having the stay point with the highest transition probability as the destination, as the prediction information.

Transmission Unit 234

The transmission unit 234 transmits the prediction information generated by the prediction unit 233 to the web server 21, for example. The transmission unit 234 transmits, as the prediction information generate by the prediction unit 233, the information related to the transition probability and the transition time to each destination, having the stay point corresponding to the position to be predicted as the starting point, and another stay point as the destination. Further, the transmission unit 234 may transmit, as the prediction information generated by the prediction unit 233, information related to the transition time, having the stay point corresponding to the position to be predicted as the starting point, and the stay point with the highest transition probability as the destination.

4. Flow of Prediction Processing

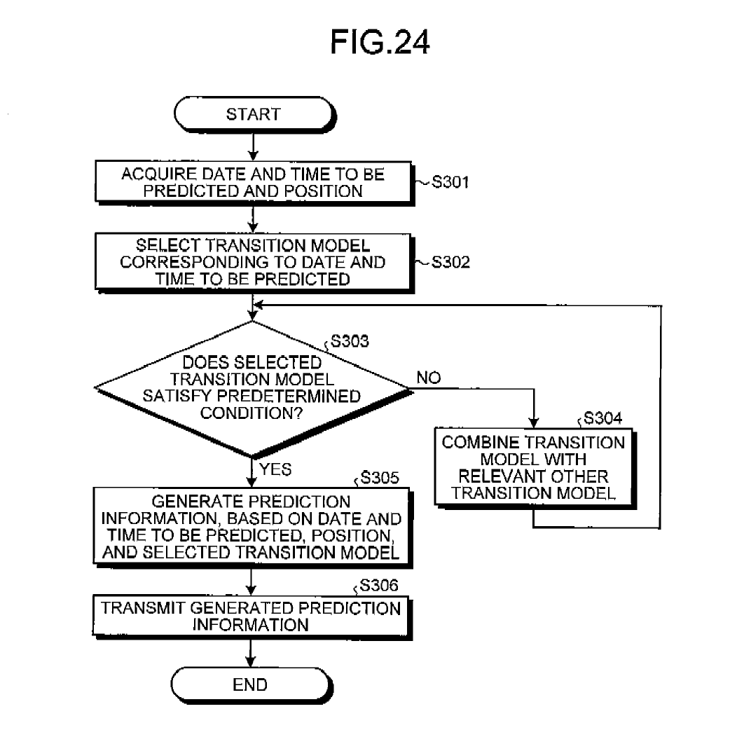

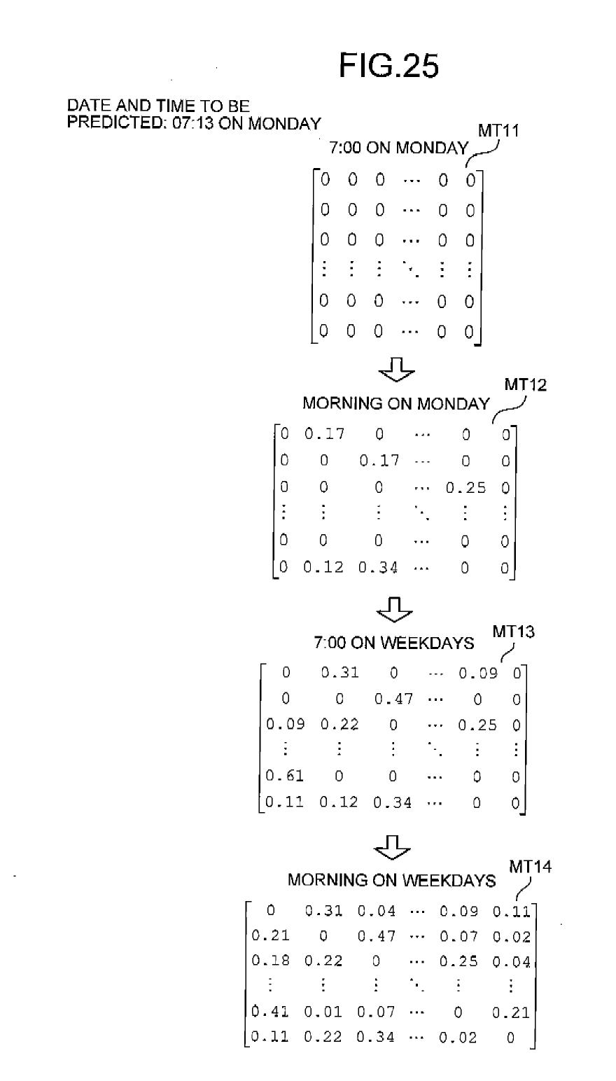

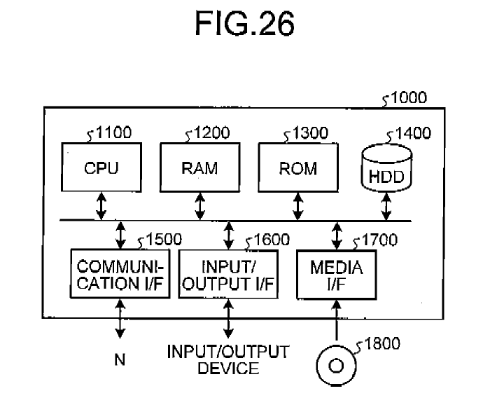

Next, a process of prediction processing after generation of the transition model by the prediction system 2 according to the second embodiment will be described using FIGS. 24 and 25. FIG. 24 is a flowchart illustrating a process of the prediction processing after generation of the transition model by the prediction system 2 according to the second embodiment. FIG. 25 is a diagram illustrating an example of combination of the transition models. Matrices MT11 to MT14 in FIG. 25 correspond to the matrix MT1 that indicates the transition probabilities in the transition models in FIG. 20.

As illustrated in FIG. 24, the prediction device 200 acquires data and time to be predicted and the position (step S301). The prediction device 200 selects the transition model corresponding to the date and time to be predicted (step S302). In the example illustrated in FIG. 25, the date and time to be predicted is “7:13 on Monday”. Therefore, the transition model of “7:00 on Monday” is selected. Note that the matrix MT11 illustrated in FIG. 25 indicates the transition probability in the transition model of “7:00 on Monday”.

The prediction device 200 then combines the selected transition model with another relevant transition model (step S304) when the selected transition model does not satisfy the predetermined condition (No in step S303). For example, the prediction device 200 may use the transition model of the same day of week and time zone as the selected transition model, or the transition model of the same time zone as the selected transition model and of another day of week, as the another relevant transition model. In the example illustrated in FIG. 25, all components in the matrix MT11 that indicates the transition probability in the selected transition model of “7:00 on Monday” are “0”. That is, in the transition model based on the position information of the user, which has been acquired during the hour from 7:00 to 7:59 on Monday, the transition time from the starting point to the destination of the user cannot be predicted. Therefore, in the example illustrated in FIG. 25, the transition model of “7:00 on Monday” with another transition model. For example, the selected transition model of “7:00 on Monday” is combined with the transition model of “8:00 on Monday” and the transition model of “9:00 on Monday”, which are the transition models of the same time zone of the morning on Monday. In the example illustrated in FIG. 25, the matrix MT12 indicates the transition probability in the transition model of “morning on Monday”, which is a combination of the selected “7:00 on Monday” with the transition model of “8:00 on Monday” or the transition model of “9:00 on Monday”. Further, for example, the selected transition model of “7:00 on Monday” is combined with the transition model of “7:00 on Tuesday”, the transition model of “7:00 on Wednesday”, the transition model of “7:00 on Thursday”, and the transition model of “7:00 on Friday”, which are the transition models of the same “7:00” but of weekdays. In the example illustrated in FIG. 25, the matrix MT13 indicates the transition probability in the transition model of “7:00 of weekdays” that is a combination of the selected transition model of “7:00 on Monday” with the transition model of “7:00 on Tuesday”, the transition model of “7:00 on Wednesday”, the transition model of “7:00 on Thursday”, and the transition model of “7:00 on Friday”.

The prediction device 200 may employ a condition that the transition probabilities to a plurality of destinations are not 0 when the stay point corresponding to the position to be predicted is the starting point as the predetermined condition in step S303. For example, in the example illustrated in FIG. 25, when the starting point that is the position to be predicted is the “office”, and when the number of components that are not 0 in the corresponding second row in the matrix MT12 or the matrix MT13 is 1 or less (No in step S303), the combining is further performed. Further, the prediction device 200 may employ a condition that density that is a ratio of the number of the transition probabilities that are not 0 to the number of all destination from the starting point (=the number of all stay points−1 (starting point)) satisfies a predetermined threshold or more when the stay point corresponding to the position to be predicted is the starting point, as the predetermined condition in step S303. Hereinafter, a case where the threshold is 0.5 will be described. For example, the prediction device 200 determines that the density is 0.3 (=3/10), and the predetermined condition is not satisfied, when the number of all destinations from a certain starting point is 10, and the number of the transition probabilities that are not 0 is 3. To be specific, when the number of all stay points is 11, and the number of components that are not 0 in the second row of matrix MT12 is 3, the density becomes 0.3. Further, the prediction device 200 determines that the density is 0.6 (=6/10), and the predetermine condition is satisfied, when the number of all destinations from a certain starting point is 10, and the number of the transition probabilities that are not 0 is 6. To be specific, when the number of all stay points is 11, and the number of components that are not 0 in the second row in the matrix MT12 is 6, the density becomes 0.6. Accordingly, the prediction device 200 combines the selected transition model, and can more appropriately perform the prediction processing. Note that the combining processing from steps S303 to S304 regarding the transition probability and the transition time of the transition model may be performed together, or may be separately performed.

Then, in the example illustrated in FIG. 25, the matrix MT14 indicates the transition probability in the further combined transition model of the “morning of weekdays”. For example, in the example illustrated in FIG. 25, when the starting point that is the position to be predicted is the “office”, there is a plurality of components that is not 0 in the corresponding second row in the matrix MT14, and thus the selected transition model satisfies the predetermined condition by the above combining (Yes in step S303). Therefore, the prediction device 200 generates the prediction information based on the date and time to be predicted and the position, and the transition model that is the selected transition model and after the combining (step S305). In the example illustrated in FIG. 25, the prediction device 200 generates the prediction information, based on the transition model that is the selected transition model, and the combined selection mode of “morning on weekdays”. Following that, the prediction device 200 transmits the generated prediction information to the web server 21 (step S306).

5. Effects

As described above, the prediction device 200 according to the second embodiment includes the acquisition unit 231 and the prediction unit 233. The acquisition unit 231 acquires the position information of the user. The prediction unit 233 predicts the time from a predetermined time when the user is positioned in the starting point that is one stay point to a predetermined time when the user is positioned in the destination that is another stay point, of the plurality of stay points of the user included in the position information of the user acquired by the acquisition unit 231, as the prediction time.

Accordingly, the prediction device 200 according to the second embodiment can appropriately predict the time from the point of time when the user is supposed to arrive at the starting point to the point of time when the user is supposed to arrive at the destination, based on the history of the position information of the user. Therefore, in a case where the user is positioned in a predetermined stay point, the prediction device 200 can appropriately predict which timing and which stay point of the other stay points the user will make a transition, as the information related to the user.

Further, in the prediction device 200 according to the second embodiment, the prediction unit 233 predicts the time obtained by adding the stay time in the starting point or the stay time in the destination, and the travel time from the starting point to the destination, as the prediction time.

Accordingly, the prediction device 200 according to the second embodiment can appropriately predict the time from the point of time when the user is supposed to arrive at the starting point to the point of time when the user is supposed to arrive at the destination, based on the history of the position information of the user. Therefore, in a case where the user is positioned in a predetermined stay point, the prediction device 200 can appropriately predict which timing and which stay point of the other stay points the user will make a transition, as the information related to the user.

Further, the prediction device 200 according to the second embodiment includes the extraction unit 232. When the speed to travel between two points based on two pieces of position information having consecutive acquired points of time is less than the predetermined threshold, the extraction unit 232 extracts the two pieces of the position information, as the starting point or the destination, from the history of the position information of the user.

Accordingly, the prediction device 200 according to the second embodiment extracts the two pieces of position information having the speed to travel between two points based on the position information being less than the predetermined threshold, thereby to eliminate the position information estimated to have the user in traveling. Therefore, the prediction device 200 can more appropriately predict the time from the point of time when the user is supposed to arrive at the starting point to the point of time when the user is supposed to arrive at the destination.

Further, in the prediction device 200 according to the second embodiment, the extraction unit 232 extracts, as the starting point or the destination, the position information that satisfies the predetermined condition, of the plurality of pieces of position information that are the consecutive pieces of position information, and have the distance between points based on the consecutive pieces of position information being less than the predetermined threshold, from the history of the position information of the user extracted by the extraction unit 232.

Accordingly, the prediction device 200 according to the second embodiment extracts the position information with the earliest or last acquired point of time, of the plurality of pieces of position information that are the consecutive pieces of position information, and have the distance between points based on the consecutive pieces of position information being less than the predetermined threshold, thereby to eliminate the position information with the earliest acquired point of time. Therefore, the prediction device 200 can more appropriately predict the time from the point of time when the user is supposed to arrive at the starting point to the point of time when the user is supposed to arrive at the destination.

Further, in the prediction device 200 according to the second embodiment, the extraction unit 232 extracts the position information with the earliest or last acquired point of time, as the position information that satisfies the predetermined condition.

Accordingly, the prediction device 200 according to the second embodiment extracts the position information with the earliest acquired point of time, of the plurality of pieces of position information that are the consecutive pieces of position information, and have the distance between points based on the consecutive pieces of position information being less than the predetermined threshold, thereby to eliminate the position information except the position information at the earliest stay point. Therefore, the prediction device 200 can more appropriately predict the time from the point of time when the user is supposed to arrive at the starting point to the point of time when the user is supposed to arrive at the destination.

Further, in the prediction device 200 according to the second embodiment, the prediction unit 233 predicts the probability to travel from the starting point to the destination, based on the history of the position information of the user.

Accordingly, the prediction device 200 according to the second embodiment can appropriately predict the probability of the user traveling from the starting point to the destination, as the information related to the user, based on the history of the position information of the user.

Further, in the prediction device 200 according to the second embodiment, the prediction unit 233 selects one transition model from the plurality of transition models generated from the history of the position information of the user, based on the predetermine date and time, combines the selected transition model with another transition model until the selected transition model satisfies the predetermined condition, and predicts the time from the point of time when the user is supposed to arrive at the starting point to the point of time when the user is supposed to arrive at the destination, based on the selected transition model.

Accordingly, the prediction device 200 according to the second embodiment can appropriately select the transition model to be used in the prediction processing, by combining the selection model selected based on the predetermined date and time with another selection model until the selected selection model satisfies the condition, and can more appropriately predict the time from the point of time when the user is supposed to arrive at the starting point to the point of time when the user is supposed to arrive at the destination.

Further, in the prediction device 200 according to the second embodiment, the prediction unit 233 uses the date and time when the position information of the user has been acquired by the acquisition unit 231, as the predetermined date and time.

Accordingly, the prediction device 200 according to the second embodiment can appropriately predict the time from the point of time when the user is supposed to arrive at the starting point to the point of time when the user is supposed to arrive at the destination, based on the date and time when the position information of the user has been acquired.

In the prediction device 200 according to the second embodiment, the prediction unit 233 predicts which timing and which stay point of the other stay points the user will travel in a case where the user is positioned in a predetermined stay point, based on the plurality of stay points of the user included in the position information of the user acquired by the acquisition unit 231 and the time when the position information has been acquired.

Accordingly, the prediction device 200 according to the second embodiment can appropriately predict the time from the point of time when the user is supposed to arrive at the starting point to the point of time when the user is supposed to arrive at the destination, based on the history of the position information of the user. Therefore, in a case where the user is positioned in a predetermined stay point, the prediction device 200 can appropriately predict which timing and which stay point of the other stay points the user will make a transition, as the information related to the user.

### First and Second Embodiments

1. Hardware Configuration

The prediction device 100 according to the first embodiment and the prediction device 200 according to the second embodiment are realized by a computer 1000 having a configuration illustrated in FIG. 26, for example. FIG. 26 is a hardware configuration diagram illustrating an example of the computer 1000 that realizes the functions of the prediction device 100 and the prediction device 200. The computer 1000 includes a CPU 1100, RAM 1200, ROM 1300, an HDD 1400, a communication interface (I/F) 1500, an input/output interface (I/F) 1600, and a media interface (I/F) 1700.

The CPU 1100 is operated based on a program stored in the ROM 1300 or the HDD 1400, and controls respective units. The ROM 1300 stores a boot program executed by the CPU 1100 at the time of startup of the computer 1000, a program depending on the hardware of the computer 1000, and the like.

The HDD 1400 stores a program executed by the CPU 1100, data used by the program, and the like. The communication interface 1500 receives data from other devices through the network N and sends the data to the CPU 1100, and transmits data generated by the CPU 1100 to other devices through the network N.

The CPU 1100 controls output devices such as a display and a printer, and input devices such as a keyboard and mouse, through the input/output interface 1600. The CPU 1100 acquires data from the input devices through the input/output interface 1600. Further, the CPU 1100 outputs the generated data to the output devices through the input/output interface 1600.

The media interface 1700 reads a program or data stored in a recording medium 1800, and provides the read program or data to the CPU 1100 through the RAM 1200. The CPU 1100 loads the program from the recording medium 1800 to the RAM 1200 through the media interface 1700, and executes the loaded program. The recording medium 1800 is an optical recording medium such as a digital versatile disc (DVD) or a phase change rewritable disk (PD), a magneto-optical recording medium such as magneto-optical disk (MO), a tape medium, a magnetic recording medium, or semiconductor memory.

For example, when the computer 1000 functions as the prediction device 100 according to the first embodiment or the prediction device 200 according to the second embodiment, the CPU 1100 of the computer 1000 realizes the functions of the control unit 130 or the control unit 230 by executing the program loaded on the RAM 1200. The CPU 1100 of the computer 1000 reads the program from the recording medium 1800 and executes the program. As another example, the CPU 1100 of the computer 1000 may acquire the program from another device through the network N.

As described above, some of embodiments of the present application have been described in detail based on the drawings. However, these embodiments are exemplarily described, and the present invention can be implemented in other forms to which various modifications and improvement are applied based on the knowledge of a person skilled in the art including the forms described in the section of the disclosure of the invention.

2. Others

The whole or a part of the processing described to be automatically performed, of the processing described in the embodiments, can be manually performed, or the whole or a part of the processing described to be manually performed, of the processing described in the embodiments, can be automatically performed by a known method. In addition, the information including the processing processes, the specific names, the various data and parameters described and illustrated in the specification and the drawings can be arbitrarily changed except as otherwise especially specified. For example, various types of information illustrated in the drawings are not limited to the illustrated information.

Further, the illustrated configuration elements of the respective devices are functional and conceptual elements, and are not necessarily physically configured as illustrated in the drawings. That is, the specific forms of distribution/integration of the devices are not limited to the ones illustrated in the drawings, and the whole or a part of the devices may be functionally or physically distributed/integrated in an arbitrary unit, according to various loads and use circumstances.

Further, the above-described embodiments can be appropriately combined within a range without causing inconsistencies in the processing content.

Further, the above-described “sections, modules, and units” can be read as “means” or “circuits”. For example, the acquisition unit can be read as acquisition means or an acquisition circuit.

According to one aspect of an embodiment, an effect to appropriately predict information related to a user is exerted.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A prediction device comprising:
an acquisition unit configured to acquire sensor information related to a first user, the sensor information having been detected with a sensor; and
a prediction unit configured to predict an interest of the first user, based on an action pattern obtained from a history of the sensor information related to the first user, the sensor information having been obtained by the acquisition unit, and interest information of user classification into which a second user is classified according to an action pattern obtained from a history of sensor information related to the second user.

2. The prediction device according to claim 1, wherein
the prediction unit predicts the user classification to which the first user belongs, based on the action pattern obtained from a history of the sensor information related to the first user, and the action pattern obtained from a history of sensor information related to the second user.

3. The prediction device according to claim 1, further comprising:
an extraction unit configured to extract, based on histories of sensor information related to a second user group, tendency items into which each sensor information included in the histories is classified according to content, and which indicate a tendency of an action of the second user group, and to extract the sensor information corresponding to each of the plurality of tendency items from the history of the sensor information of each second user, wherein
the prediction unit predicts the interest of the first user, using the interest information of each user classification into which the second user is classified based on distribution of the sensor information corresponding to each of the plurality of tendency items extracted by the extraction unit.

4. The prediction device according to claim 3, wherein
the extraction unit extracts the sensor information corresponding to each of the plurality of tendency items from the history of the sensor information of the first user, and
the prediction unit predicts the interest of the first user, from the interest information of the user classification into which the first user is classified based on the degree of similarity between distribution of the sensor information corresponding to each of the plurality of tendency items in the first user, the sensor information having been extracted by the extraction unit, and distribution of the sensor information corresponding to each of the plurality of tendency items associated with each user classification.

5. The prediction device according to claim 3, wherein
the extraction unit extracts the interest information of the user classification from the interest information of the plurality of second users classified into the user classification.

6. The prediction device according to claim 1, wherein
the acquisition unit acquires position information of the first user detected with the sensor, as the sensor information of the first user, and
the prediction unit predicts the interest of the first user, based on an action pattern obtained from a history of the position information of the first user, the position information having been acquired by the acquisition unit, and interest information of user classification into which the second user is classified according to an action pattern obtained from a history of position information of the second user.

7. A prediction method comprising the steps of:
acquiring sensor information related to a first user, the sensor information having been detected with a sensor; and
predicting an interest of the first user, based on an action pattern obtained from a history of the sensor information related to the first user, the sensor information having been obtained in the acquiring step, and interest information of user classification into which a second user is classified according to an action pattern obtained from a history of sensor information related to the second user.

8. A non-transitory computer-readable storage medium with an executable program stored thereon, wherein the program instructs a computer to perform:
acquiring sensor information related to a first user, the sensor information having been detected with a sensor; and
predicting an interest of the first user, based on an action pattern obtained from a history of the sensor information related to the first user, the sensor information having been obtained in the acquiring process, and interest information of user classification into which a second user is classified according to an action pattern obtained from a history of sensor information related to the second user.

9. A prediction device comprising:
an acquisition unit configured to acquire position information of a user; and
a prediction unit configured to predict, as a prediction time, a time from a predetermined time when the user is positioned in a starting point that is one stay point to a predetermined time when the user is positioned in a destination that is another stay point, of a plurality of stay points of the user included in the position information of the user acquired by the acquisition unit.

10. The prediction device according to claim 9, wherein
the prediction unit predicts, as the prediction time, a time obtained by adding a stay time in the starting point or a stay time in the destination, and a travel time from the starting point to the destination.

11. The prediction device according to claim 9, further comprising:
an extraction unit configured to extract, when a speed to travel between two points based on two pieces of the position information with consecutive acquired points of time is less than a predetermined threshold, the two pieces of the position information from a history of the position information of the user, as the starting point or the destination.

12. The prediction device according to claim 11, wherein
the extraction unit extracts the position information that satisfies a predetermined condition, of a plurality of pieces of the position information with consecutive acquired points of time, and having a distance between points based on the consecutive pieces of position information being less than a predetermined threshold, from a history of the position information of the user extracted by the extraction unit, as the starting point or the destination.

13. The prediction device according to claim 12, wherein
the extraction unit extracts the position information with an earliest or last acquired point of time, as the position information that satisfies the predetermined condition.

14. The prediction device according to claim 9, wherein
the prediction unit predicts a probability to travel from the starting point to the destination, based on a history of the position information of the user.

15. The prediction device according to claim 9, wherein
the prediction unit selects one transition model, based on predetermined date and time, from a plurality of transition models generated from a history of the position information of the user, combines the selected transition model with another transition model until the selected transition model satisfies a predetermined condition, and predicts the prediction time, based on the selected transition model.

16. The prediction device according to claim 15, wherein
the prediction unit determines date and time when the position information of the user has been acquired by the acquisition unit, as the predetermined date and time.

17. A prediction device comprising:
an acquisition unit configured to acquire position information of a user; and
a prediction unit configured to predict which timing and which stay point of other stay points the user travels, when the user is positioned in a predetermined stay point, based on a plurality of stay points of the user included in the position information of the user acquired by the acquisition unit, and a time when the position information has been acquired.

18. A prediction method executed by a computer, the method comprising the steps of:
acquiring position information of a user; and
predicting, as a prediction time, a time from a predetermined time when the user is positioned in a starting point that is one stay point to a predetermined time when the user is positioned in a destination that is another stay point, of a plurality of starting points of the user included in the position information of the user acquired by the acquiring step.

19. A non-transitory computer-readable storage medium with an executable program stored thereon, wherein the program instructs a computer to perform:
acquiring position information of a user; and predicting, as a prediction timer a time from a predetermined time when the user is positioned in a starting point that is one stay point to a predetermined time when the user is positioned in a destination that is another stay point, of a plurality of starting points of the user included in the position information of the user acquired by the acquiring process.
